(19) United States
(12) Patent Application Publication
(10) Pub. No.: US 2026/0358526 A1
(43) Pub. Date: Nov. 12, 2026

(54) DISPLACEMENT SYSTEM, DEVICE, AND METHOD

(71) Applicant: PLANAR MOTOR INCORPORATED, Vancouver (CA)

(72) Inventors: Rui CHEN, White Rock (CA); Jesse LI, Vancouver (CA); Graham WILLIAMSON, Vancouver (CA); Xiaodong LU, Vancouver (CA); Yao Kevin XIAO, White Rock (CA); Zhaowei LU, Coquitlam (CA); Yakov SHKLAROV, Richmond (CA)

(21) Appl. No.: 19/139,124

(22) PCT Filed: Dec. 15, 2023
(86) PCT No.: PCT/CA2023/051681

§ 371 Date: Jun. 13, 2025

Related U.S. Application Data
(60) Provisional application No. 63/432,954, filed on Dec. 15, 2022.

(51) Int. Cl. G01V 3/08; B65G 54/02

(52) U.S. Cl. CPC G01V 3/081; B65G 54/02; B65G 2203/0266; B65G 2203/043

(57) ABSTRACT

Aspects of the present disclosure provide methods, devices and systems for facilitating the identification of a mover device in a displacement system. A method of identifying a mover may include receiving at least one input signal representing at least one measurement of a magnetic field from at least one reference location relative to the mover. The method may further include identifying the mover in response to at least the at least one measurement of the magnetic field.

### RELATED APPLICATION

This application claims the benefit of and priority from U.S. provisional patent application No. 63/432,954, filed Dec. 15, 2022, the entire contents of which are incorporated herein by reference.

### FIELD

This disclosure relates to a displacement system, device, and method.

### BACKGROUND

Displacement systems, such as XY tables and rotary tables, are widely used in various manufacturing, inspection and assembling processes. These systems include a stator module and a moveable stage, typically referred to as a robotic device or mover device. The stator module actuates the moveable stage.

A common solution currently in use achieves XY motion by stacking two linear stages (i.e. an X-stage and a Y-stage) together via connecting bearings. A more desirable solution involves having a single moving stage capable of XY motion, eliminating additional bearings. It is also desirable for such a moving stage to provide at least some Z motion. Attempts have been made to design such displacement devices using the interaction between current-carrying coils and permanent magnets. Examples of efforts in this regard include the following: U.S. Pat. Nos. 6,003,230; 6,097,114; 6,208,045; 6,441,514; 6,847,134; 6,987,335; 7,436,135; 7,948,122; US patent publication No. 2008/0203828; W. J. Kim and D. L. Trumper, High-precision magnetic levitation stage for photolithography, Precision Eng. 22 2 (1998), pp. 66-77; D. L. Trumper, et al, “Magnet arrays for synchronous machines”, IEEE Industry Applications Society Annual Meeting, vol. 1, pp. 9-18, 1993; and J. W. Jansen, C. M. M. van Lierop, E. A. Lomonova, A. J. A. Vandenput, “Magnetically Levitated Planar Actuator with Moving Magnets”, IEEE Tran. Ind. App., Vol 44, No 4, 2008.

More recent techniques for implementing displacement systems having a moveable stage and a stator are described in: PCT application No. PCT/CA2012/050751 (published under WO/2013/059934) entitled DISPLACEMENT DEVICES AND METHODS FOR FABRICATION, USE AND CONTROL OF SAME; PCT application No. PCT/CA2014/050739 (published under WO/2015/017933) entitled DISPLACEMENT DEVICES AND METHODS AND APPARATUS FOR DETECTING AND ESTIMATING MOTION ASSOCIATED WITH SAME; PCT application No. PCT/CA2015/050549 (published under WO/2015/188281) entitled DISPLACEMENT DEVICES, MOVEABLE STAGES FOR DISPLACEMENT DEVICES AND METHODS FOR FABRICATION, USE AND CONTROL OF SAME; PCT application No. PCT/CA2015/050523 (published under WO/2015/184553) entitled METHODS AND SYSTEMS FOR CONTROLLABLY MOVING MULTIPLE MOVEABLE STAGES IN A DISPLACEMENT DEVICE; and PCT application No. PCT/CA2015/050157 (published under WO/2015/179962) entitled DISPLACEMENT DEVICES AND METHODS FOR FABRICATION, USE AND CONTROL OF SAME.

### SUMMARY

Embodiments of the present disclose may provide methods, devices and systems that allow for the identification of a mover device.

According to at least one embodiment, there is disclosed method of identifying a mover, the method comprising: receiving at least one input signal representing at least one measurement of a magnetic field from at least one reference location relative to the mover; and identifying the mover in response to at least the at least one measurement of the magnetic field.

In some embodiments, identifying the mover in response to at least the at least one measurement of the magnetic field comprises determining, for each reference location of one or more of the at least one reference location, a characterization of the magnetic field of the reference location.

In some embodiments, determining the characterization of the magnetic field comprises identifying the magnetic field as having one of at least two different available characterizations for the magnetic field of the one or more of the at least one reference location.

In some embodiments, the at least two different available characterizations for the magnetic field from a reference location comprise: a magnetic field resulting from a magnet at the reference location and polarized in a first direction relative to the mover; and a magnetic field resulting from a magnet at the reference location and polarized in a second direction relative to the mover and different from the first direction.

In some embodiments, determining the characterization of the magnetic field comprises identifying the magnetic field as having one of at least three different available characterizations for the magnetic field of the one or more of the at least one reference location.

In some embodiments, the at least three different available characterizations for the magnetic field from a reference location comprise: a magnetic field resulting from a magnet at the reference location and polarized in a first direction relative to the mover; a magnetic field resulting from a magnet at the reference location and polarized in a second direction relative to the mover and different from the first direction; and an absence of a magnet at the reference location.

In some embodiments, the at least two different available characterizations for the magnetic field from a reference location comprise: a magnetic field resulting from a magnet at the reference location with a first magnetic blemish; and a magnetic field resulting from a magnet at the reference location with a second magnetic blemish, wherein the second magnetic blemish is different from the first magnetic blemish.

In some embodiments, the first magnetic blemish is intentionally created.

In some embodiments, the different available characterizations for the magnetic field of the one or more of the at least one reference location comprise different magnetic field strengths of magnets at the one or more of the at least one reference location.

In some embodiments, the method further comprises pre-processing the at least one input signal to create at least one pre-processed signal, wherein identifying the mover comprises identifying the mover in response to at least the at least one pre-processed signal.

In some embodiments, pre-processing the at least one input signal comprises high-pass filtering the at least one input signal.

In some embodiments, pre-processing the at least one input signal comprises low-pass filtering the at least one input signal.

In some embodiments, pre-processing the at least one input signal comprises band-pass filtering the at least one input signal.

In some embodiments, the method further comprises identifying at least a position of the mover in response to at least the at least one measurement of the magnetic field.

In some embodiments, the method further comprises identifying at least an orientation of the mover in response to at least the at least one measurement of the magnetic field.

In some embodiments, the method further comprises causing at least one sensor to measure the at least one measurement of the magnetic field.

In some embodiments, causing the at least one sensor to measure the at least one measurement of the magnetic field comprises causing the at least one sensor to measure the at least one measurement of the magnetic field while the mover is moving.

In some embodiments, causing the at least one sensor to measure the at least one measurement of the magnetic field comprises causing the at least one sensor to measure the at least one measurement of the magnetic field while the mover is levitating.

In some embodiments, identifying the mover comprises distinguishing the mover from other movers.

In some embodiments, identifying the mover comprises identifying the mover in response to at least an identification of the mover associated in at least one database with the magnetic field from the at least one reference location.

In some embodiments, the at least one measurement of the magnetic field represents at least magnetic influence from at least one actuation magnet on the mover.

In some embodiments, identifying the mover comprises identifying the mover according to at least the magnetic influence from the at least one actuation magnet.

In some embodiments, the at least one actuation magnet comprises a plurality of actuation magnets, and identifying the mover comprises identifying the mover according to at least the magnetic influence from the plurality of actuation magnets and relative spatial characteristics of the actuation magnets with respect to each other.

In some embodiments, identifying the mover comprises identifying a relative pitch between two or more of the plurality of actuation magnets.

In some embodiments, identifying the mover comprises identifying an orientation between two or more of the plurality of actuation magnets.

In some embodiments, the at least one measurement of the magnetic field represents at least magnetic influence from at least one identifying magnet on the mover.

In some embodiments, identifying the mover comprises identifying the mover according to at least the magnetic influence from the at least one identifying magnet.

In some embodiments, identifying the mover comprises identifying the mover in response to at least movement of one or more of the at least one identifying magnet relative to the mover.

In some embodiments, identifying the mover comprises identifying the mover in response to at least oscillation of the one or more of the at least one identifying magnet relative to the mover.

In some embodiments, the method further comprises causing the mover to move, wherein causing the mover to move comprises causing one or more external magnetic fields to interact with the at least one actuation magnet.

In some embodiments, the method further comprises causing the mover to move, wherein causing the mover to move comprises causing one or more external magnetic fields to interact with the at least one actuation magnet independently of the at least one identifying magnet.

In some embodiments, the method is performed by at least one processor.

In some embodiments, at least one computer-readable medium comprises instructions stored thereon that, when executed by at least one processor, cause the at least one processor to perform the method as disclosed herein.

According to at least one embodiment, there is disclosed a mover device comprising: a mover comprising at least one actuation magnet configured to generate forces for moving the mover device in response to at least one external magnetic field; and at least one identifying magnet, wherein the at least one identifying magnet is encoded with identification information distinguishing the mover from other movers.

In some embodiments, the at least one identifying magnet comprises a plurality of identifying magnets.

In some embodiments, the mover defines a plurality of reference locations, and wherein each identifying magnet of the plurality of identifying magnets is at a respective different one of the plurality of reference locations.

In some embodiments, the plurality of reference locations are in at least one column and at least one row on the mover, wherein magnetic fields of any magnets in each of the at least one column and each of the at least one row counteract each other when combined together.

In some embodiments, at least some of the plurality of reference locations are in a periphery of the mover surrounding the at least one actuation magnet.

In some embodiments, at least some of the plurality of reference locations are surrounded by the at least one actuation magnet.

In some embodiments, the plurality of identifying magnets are configured to permit altering the identification information.

In some embodiments, the plurality of identifying magnets are individually removable from the mover device.

In some embodiments, the plurality of identifying magnets are individually repositionable within the mover device to alter polarities of the plurality of identifying magnets individually relative to the mover.

In some embodiments, each actuation magnet of the at least one actuation magnet has a length in a longest dimension of the actuation magnet, and the length of each actuation magnet of the at least one actuation magnet is larger than a length in a longest dimension of each identifying magnet of the plurality of identifying magnets.

In some embodiments, each actuation magnet of the at least one actuation magnet has a length in a longest dimension of the actuation magnet, and the length of each actuation magnet of the at least one actuation magnet is more than 50% larger than a length in a longest dimension of each identifying magnet of the plurality of identifying magnets.

In some embodiments, each actuation magnet of the at least one actuation magnet has a length in a longest dimension of the actuation magnet, and the length of each actuation magnet of the at least one actuation magnet is more than 100% larger than a length in a longest dimension of each identifying magnet of the plurality of identifying magnets.

In some embodiments, each actuation magnet of the at least one actuation magnet has a magnetic field strength, and the magnetic field strength of each actuation magnet of the at least one actuation magnet is larger than a magnetic field strength of each identifying magnet of the plurality of identifying magnets.

In some embodiments, each actuation magnet of the at least one actuation magnet has a magnetic field strength, and the magnetic field strength of each actuation magnet of the at least one actuation magnet is more than 10% larger than a magnetic field strength of each identifying magnet of the plurality of identifying magnets.

In some embodiments, each actuation magnet of the at least one actuation magnet has a magnetic field strength, and the magnetic field strength of each actuation magnet of the at least one actuation magnet is more than 30% larger than a magnetic field strength of each identifying magnet of the plurality of identifying magnets.

In some embodiments, the at least one actuation magnet comprises a plurality of actuation magnets having a magnetic pitch, and the plurality of identifying magnets have a magnetic pitch different from the magnetic pitch of the plurality of actuation magnets.

In some embodiments, at least three of the plurality of identifying magnets are arranged generally in a line with a non-uniform magnetic oscillation, wherein a first magnetic pitch between first and second identifying magnets of the plurality of identifying magnets is different from a second magnetic pitch between second and third identifying magnets of the plurality of identifying magnets.

In some embodiments, at least three of the plurality of identifying magnets are arranged generally in a line with a non-uniform magnetic oscillation comprising two sequential magnets with similar magnetic orientation.

In some embodiments, magnetic fields from the plurality of identifying magnets are rotationally asymmetric about an axis surrounded by the plurality of identifying magnets.

In some embodiments, the mover device is wrapped in conductive material.

In some embodiments, two identifying magnets of the plurality of identifying magnets have the same magnetic orientation but a measurably different magnetic strength from each other.

In some embodiments, two identifying magnets of the plurality of identifying magnets have a measurably different vertical position within the mover device.

In some embodiments, at least one of the plurality of identifying magnets is movable relative to the mover.

In some embodiments, the mover device further comprises at least one non-rigid connector connecting the at least one of the plurality of identifying magnets to the mover device to permit movement of the at least one of the plurality of magnets relative to the mover.

In some embodiments, the at least one non-rigid connector is at least one resilient body.

In some embodiments, the at least one resilient body is at least one spring.

In some embodiments, the at least one actuation magnet comprises two or more actuation magnets.

In some embodiments, the two or more actuation magnets are configured to generate forces for moving the mover device in at least two degrees of freedom.

According to at least one embodiment, there is disclosed a displacement system comprising: a mover device as disclosed herein. The displacement system further comprises at least one stator comprising: at least one coil positioned to generate the at least one external magnetic field; and at least one sensor positioned to measure at least a magnetic field from at least the at least one identifying magnet when the mover device is positioned within a sensor range of the at least one sensor. The displacement system further comprises a controller configured to identify the mover device in response to at least the magnetic field measured by the at least one sensor according to the method as disclosed herein.

According to at least one embodiment, there is disclosed a displacement system comprising a mover device comprising a mover comprising at least one actuation magnet configured to generate forces for moving the mover device in response to at least one external magnetic field. The displacement system further comprises at least one stator comprising: at least one coil positioned to generate the at least one external magnetic field; and at least one sensor positioned to measure at least a magnetic field from at least the at least one actuation magnet when the mover device is positioned within a sensor range of the at least one sensor; and a controller configured to identify the mover device in response to at least the magnetic field measured by the at least one sensor according to the method disclosed herein.

In some embodiments, the stator comprises a working surface and a layer of conductive material, wherein the layer of conductive material is disposed along the working surface between the stator and the mover device.

In some embodiments, the stator is enclosed by a conductive material.

### BRIEF DESCRIPTION OF DRAWINGS

FIG. 1 is a side view of a displacement system according to one embodiment.

FIG. 2 is a block diagram of a controller used in the displacement system of FIG. 1.

FIG. 3 is a top view of a mover device used in the displacement system of FIG. 1.

FIG. 4A is a top view of the mover device of FIG. 3, indicating possible locations for a magnetic identifying element.

FIGS. 4B-4E are top views of the mover device of FIG. 3, depicting possible configurations of the magnetic identifying element.

FIGS. 5A-5B are top views of the mover device of FIG. 3, depicting possible configurations of the magnetic identifying element.

FIG. 6A is a top view of the mover device of FIG. 3, depicting a possible configuration of actuation magnets.

FIG. 6B is a top view of an actuation magnet of FIG. 6A, depicting a possible configuration of actuation magnets.

FIG. 6C is a top view of the mover device of FIG. 3, depicting another possible misalignment of the actuation magnets.

FIG. 6D is a side view of the displacement system of FIG. 1, depicting another possible misalignment of the actuation magnets.

FIGS. 7A-7C are top views of the mover device of FIG. 3, depicting possible configurations of the actuation magnets.

FIG. 8 is an exploded view of the mover device of FIG. 3.

FIG. 9 is a side view of the displacement system of FIG. 1, indicating measurement of the magnetic identifying element.

FIG. 10 is a top view of the displacement system of FIG. 1, depicting two mover devices interacting.

FIGS. 11A-11B are top views of the mover device of FIG. 3, used for orientation detection.

FIG. 12A is a side view of the displacement system of FIG. 1, indicating inconsistent magnet spacing in the magnetic identifying element.

FIG. 12B is a graph depicting a magnetic field strength curve measured by a sensor in the displacement system of FIG. 1.

FIG. 13 is a side view of the displacement system of FIG. 1, including non-rigid connectors in the magnetic identifying element.

FIG. 14 is a side view of the mover device of FIG. 3, enclosed in a wrapping layer.

FIG. 15A is a side view of the displacement system of FIG. 1, including a separating layer.

FIG. 15B is a side view of the displacement system of FIG. 1, including the separating layer and the wrapping layer.

FIG. 16 is a flow diagram of a method for determining the orientation and identification information of the mover device of FIG. 3.

FIG. 17 is a flow diagram of a method for identifying the mover device of FIG. 3.

FIG. 18 is a flow diagram of another method for identifying the mover device of FIG. 3.

FIG. 19 is a flow diagram of a method for identifying the mover device of FIG. 3 based on spring oscillation.

FIG. 20 is a flow diagram of a method for identifying the mover device of FIG. 3 based measurements from more than one position.

### DETAILED DESCRIPTION

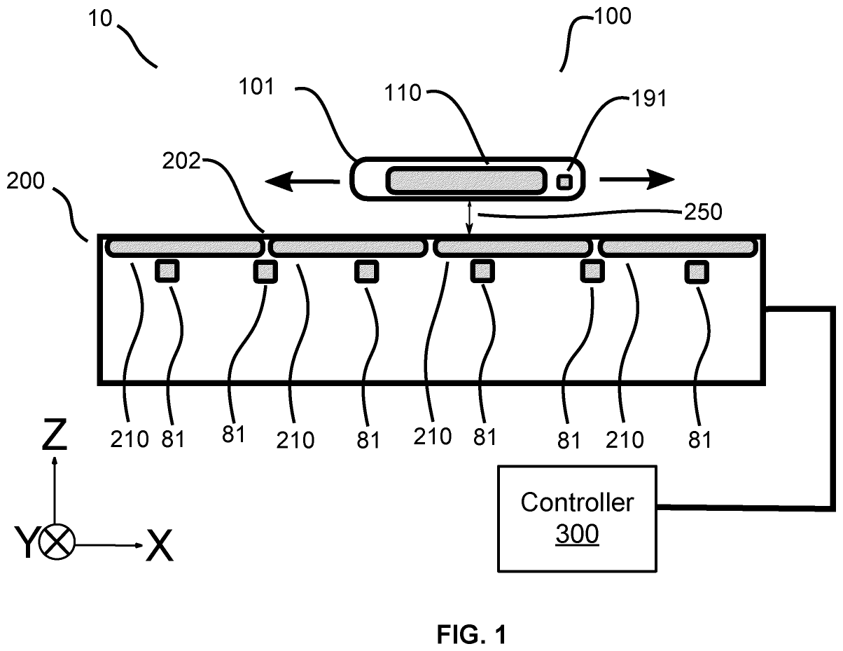

FIG. 1 depicts a displacement system 10. Generally, displacement system 10 conveys components, products or workpieces (not shown) across displacement system 10. Displacement system 10 includes a mover device 100, a stator module 200 and a controller 300.

Mover device 100 moves across displacement system 10, and may also hold components, products or workpieces for conveying across displacement system 10. In particular, mover device 100 may carry one or more parts, such as but not limited to one or more biological samples, devices, drugs, drugs in a suitable container, product being assembled, raw parts and/or materials.

Mover device 100 may also be referred to as a robotic device or a mover stage.

Stator module 200 supports and actuates mover device 100, such that mover device 100 travels across stator module 200 to another location in displacement system 10.

Controller 300 controls stator module 200 and mover device 100. Controller 300 may be directly connected to stator module 200 using a wired or wireless connection, and may control mover device 100 indirectly through stator module 200. Alternatively, controller 300 may also be connected to mover device 100 using a wired or wireless connection, such that controller 300 may communicate with mover device 100 directly. In some embodiments, controller 300 may be completely integrated with stator module 200.

For example, a high speed data cable may be used, such as an ethernet cable, a HDMI cable, or any cable of sufficient data rate bandwidth. In embodiments where controller 300 is completely integrated within stator module 200, any method of electrical connection may be used, such as ribbon cables, edge board connectors, wire connectors, headers and pins, etc. A wireless connection may include Bluetooth, WiFi, Zigbee, Cellular, NFC, etc.

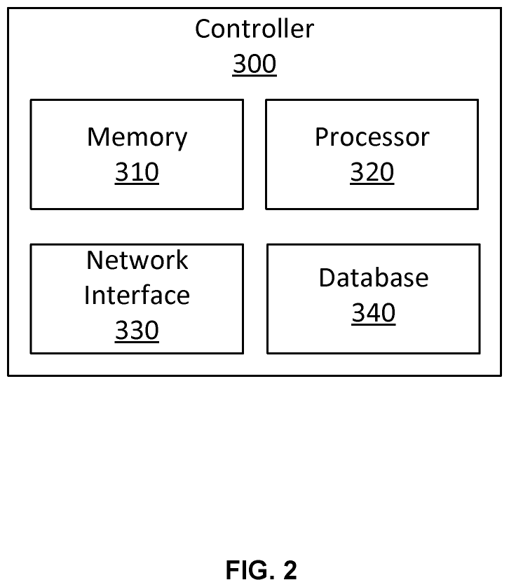

As depicted in FIG. 2, controller 300 may include a memory 310 and a processor 320. It may also include a network interface 330. Network interface 330 may be used to connect to stator module 200. Alternatively, stator module 200 may connect to controller 300 through another connection. As well, controller 300 may directly integrated into stator module 200 without any external connections.

Processor 320 may be an intel or AMD x86-based processor, or an ARM-based processor, FPGA, or any other suitable processor.

Memory 310 (e.g. RAM) includes a computer-readable storage space accessible by processor for storage of working data and code. Memory 310 also includes persistent computer-readable storage containing instructions for execution by processor and for storage of data collected by sensors 81. Memory may include any one or more suitable memory types, such as flash memory, hard drives or the like.

Network interface 330 may be any suitable wired or wireless device connecting controller 300 to a network for communication with a data host. Network interface may be, for example, an Ethernet or IEEE 802.11 (Wi-Fi) network adapter. Network interface may include an antenna for transmitting data, receiving data or both. In some embodiments, the network interface may include multiple antennas, such as antennas in a phased array, and may connect to a LAN or WAN using a steered beam. The network interface may also include a direct connection between stator module 200 and controller 300.

Controller 300 may also include a database 340. Database 340 may store configuration settings and identification information for mover device 100, as well as settings and information pertaining to other movers. In some embodiments, database 340 may be part of controller 300. In other embodiments, database 340 may be external to controller 300, and may be accessible by controller 300 via network interface 330 or another wired or wireless connection.

In some embodiments, more than one controller may be used within displacement system 10. For example, controller 300 may only control stator module 200 or a group of stators including stator module 200, while another controller may control another stator or group of stators.

Generally, mover device 100 and stator module 200 may interact with each other via one or more magnetic fields, so that stator module 200 can provide forces and torques to mover device 100 to controllably move mover device 100. Controller 300 may determine and provide commands to stator module 200 to generate specific forces and torques to move mover device 100.

It will be appreciated that displacement system 10 may include one or more mover devices 100 and one or more stator modules 200. Mover device 100 includes a mover 101 and a magnetic identifying element 191. Mover 101 includes at least one actuation magnet 110. Examples of such actuation magnets 110 are described and illustrated in United States patent no. U.S. Pat. No. 10,222,237 (incorporated herein by reference) as arrays of permanent magnets 112A, 112B, 112C, 112D (or collectively, magnet arrays 112), each having corresponding magnetization segments 114.

It will be appreciated that in some embodiments, mover 101 includes a plurality of actuation magnets 110. For example, at least one actuation magnet 110 may include a plurality of smaller magnets (collectively referred to as actuation magnets 110). In other embodiments, at least one actuation magnet 110 may only be a single actuation magnet 110.

In some embodiments, mover device 100 may also include more than one magnetic identifying element 191.

Actuation magnets 110 are configured to respond to one or more external magnetic fields, and in particular are configured to generate forces for moving mover 101 and thus mover device 100 in response to one or more external magnetic fields. Actuation magnets 110 may include an alternating magnetic field extending along a first direction and linearly elongated along another direction.

Magnetic identifying element 191 is encoded with information identifying mover device 100. For example, magnetic identifying element 191 may include identification information representing a serial number, identification number or other distinguishing information for mover device 100. Identification information may be used to distinguish mover device 100 from other mover devices.

In some particular embodiments, magnetic identifying element 191 may be used to identify mover device 101 for specific processes and therefore be non unique and adjustable by a user.

As will be discussed in further detail below, magnetic identifying element 191 may also be configurable to alter identification information stored in magnetic identifying element 191. For example, magnetic identifying element 191 may be re-encoded with new identification information.

In addition to identification information, magnetic identifying element 191 may also be encoded with other information, such as non-identification information for mover device 100.

In some embodiments, mover device 100 may also store information, such as additional identification information, in a radio frequency identification (RFID) tag or in some other information storing device. For example, a computer memory may be used to store additional information, which may include a solid-state memory, a disk, and any other suitable computer memory types, such as flash memory, hard drives or the like.

As will be discussed in further detail below, information for distinguishing mover device 100 from other movers may additionally or alternatively be stored in actuation magnets 110.

Stator module 200 includes a sensor 81 and a coil 210. Sensor 81 is configured to measure at least one magnetic field. Sensor 81 may only accurately measure a magnetic field within a certain range of sensor 81. Examples of such sensors 81 are described and illustrated in United States patent no. U.S. Pat. No. 10,222,237 as magnetic field sensors 501. Such sensors may include, for example, Hall-effect magnetic field sensors, magneto-resistive sensors, and/or other suitable types of magnetic field sensors that can measure magnetic flux density.

Coil 210 is configured to generate at least one external magnetic field. Examples of such coils 210 are described and illustrated in United States patent no. U.S. Pat. No. 10,222,237 as coil traces 126.

As will be discussed in more detail below, stator module 200 is configured to generate at least one external magnetic field that interacts with at least one actuation magnet 110 on mover device 100, to provide forces and torques to mover device 100.

It will be appreciated that in some embodiments, stator module 200 may include more than one sensor 81 (collectively referred to as sensors 81) and/or more than one coil 210 (collectively referred to as coils 210).

For example, stator module 200 may include a plurality of coils 210, each configured to generate one or more external magnetic fields. At least one of coils 210 may be a linear coil.

The layout of coils 210 may include a first group of coils that are linearly elongated in a first direction. First group of coils may also include a second coil pitch in a second direction. Coils 210 may also include a second group of coils that are linearly elongated in a second direction. Second group of coils may also include a first coil pitch in the first direction. The first and second coil pitch may be equal.

Sensors 81 may include one or more flyaway sensors.

Coils 210 and sensors 81 may be arranged in a pattern on stator module 200, for example as described and illustrated in United States patent no. U.S. Pat. No. 10,222,237. Patterns may include one or more sensors 81 configured around each of coils 210, such as one sensor 81 at each edge or coil 210. Other patterns may also be possible. It will be appreciated that sensors 81 may be patterns near or around coils 210 to provide proper feedback to controller 300 for mover device 100 control, and also for position sensing and mover device 100 identification, as discussed further below. Coils 210 may be linearly elongated in different directions (i.e. linearly elongated in X direction or linearly elongated in Y direction) and may vertically overlap with other coils.

Stator module 200 includes a working surface 202 for mover device 100 to move upon. Generally, working surface 202 describes a continuous area upon which mover device 100 may be controlled by stator module 200. Suitable feedback control algorithms executed by controller 300 and suitable position feedback from sensors 81 allow controller 300 and stator module 200 to move and control mover device 100.

Working surface 202 may be flat, curved, cylindrical, spherical or some other shape that allows mover device 100 to move along working surface 202. In some further embodiments, a combined working surface may be defined by a plurality of stator modules, such that each working surface 202 of each stator module 200 may be combined into a larger combined working surface. While working surface 202 is depicted horizontally, it should be understood that working surface 202 can be mounted vertically or at an angle to gravity.

As will be discussed in greater detail below, mover device 100 moves along working surface 202 in a contact mode or a non-contact mode. Contact mode may involve contact media such as sliding and/or rolling bearings. Non-contact mode may require maintaining a controllable gap 250 between mover device 100 and working surface 202 of stator module 200 in a normal direction. Gap 250 may be an air gap. Mover device 100 may also rest upon working surface 202 without moving, which may be in a contact mode or a non-contact mode.

Mover device 100 may have six degrees of freedom (6-DOF) controllable motion (active levitation mode) or without any contact by maintaining gap 250 between mover device 100 and working surface 202 in a normal direction to working surface 202 by passive levitation means (i.e. passive levitation mode). In the passive levitation mode, mover device 100 may rest above working surface 202 in the non-contact mode.

In some embodiments, one or more amplifiers (not shown) may be connected to coils 210. Amplifiers may drive one or more electrical currents in coils 210, generating one or more external magnetic fields. Controller 300 may be connected to deliver control signals to the one or more amplifiers. The control signals may be used to control current driven by the one or more amplifiers into coil 210. As previously noted, stator module 200 may include a plurality of coils 210, which are each driven by the amplifiers. The current controllably driven into a coil 210 may cause coil 210 to create at least one external magnetic field. The at least one external magnetic field causes corresponding magnetic forces to act on mover device 100. The one or more external magnetic fields may act on actuation magnets 110, thereby moving mover device 100 relative to stator module 200, such as across working surface 202. Mover device 100 may be controllable in at least 2 in-plane DOF motions, including but not being limited to 3 in-plane DOF controllable motions and 6-DOF controllable motions. In general, embodiments such as those described herein may involve one or more mover devices that are controllably movable relative to a stator or a working surface in at least 2 in-plane DOF motions, in 3 in-plane DOF motions, in 4 in-plane DOF motions, in 5 in-plane DOF motions, or in 6-DOF controllable motions, for example.

In some embodiments, the magnetic forces associated with the interaction between the magnetic fields created by the currents in coils 210 and the magnetic fields associated with actuation magnet 110 may attract mover device 100 toward stator module 200 at all times when controller 300 is controlling the currents driven by the one or more amplifiers.

In other embodiments, the magnetic forces associated with the interaction between the magnetic fields created by the currents in coils 210 and the magnetic fields associated with actuation magnet 110 may force mover device 100 away from stator module 200 to balance gravitational forces with gap 250 at all times. As discussed above, controller 300 may control the currents driven by the one or more amplifiers.

In some embodiments, the gap 250 between mover device 100 and stator module 200 is maintained by air bearings or compressed-fluid bearings. It will be appreciated that in some embodiments, gap 250 may be zero, such as when mover device 100 operates in contact mode. Contact mode may involve contact media such as sliding and/or rolling bearings between mover device 100 and working surface 202.

As previously discussed, in some embodiments mover device 100 may work in levitation mode, i.e. be levitated near working surface 202 without contacting stator module 200. Levitation mode may be in either a passive way (i.e. passive levitation mode) or in an active way (i.e. active levitation mode), and move along working surface 202 in X and Y directions, where X and Y are two non-parallel (e.g., orthogonal) directions inside working surface 202. It will be appreciated that gap 250 between working surface 202 and mover device 100 is much smaller than the mover travel dimensions in X and Y.

Although mover device 100 may be capable of 6-DOF controllable motion, this may not be necessary in all situations. In certain embodiments, levitation of mover device 100 may not be needed and heavy load carrying capability may be more important. In those embodiments, it should be understood that mover device 100 may sit on working surface 202 with proper mechanical bearing, such as planar sliding bearings and/or ball transfer units. In such embodiments, mover device 100 may be capable of three in-plane DOF controllable motion (translation in X and Y and rotation around Z), where X and Y are two non-parallel directions (e.g., orthogonal) in working surface 202 and Z is normal to working surface 202.

When mover device 100 relies on sliding and/or rolling bearings to sit on working surface 202 and mover device 100 is capable of 3 in-plane DOF controllable motion (translation in X and Y and rotation around Z), it may be working in the 3-DOF controlled sitting mode.

In some embodiments, mover device 100 is capable of 3-DOF controllable motions (translations in X and Y and rotation around Z) working in levitation mode without contact with working surface 202. In this mode, translation in Z, rotation around X and rotation around Y (and thus associated DOF) of mover device 100 may be open-loop controlled without feedback, using suitable passive levitation technology. When a mover is capable of 3-DOF controllable motion without contact to stator, it may be working in the 3-DOF controlled levitation mode.

Mover device 100 may be controlled to move to one or more suitable identifying positions where magnetic identifying element 191 aligns with a corresponding set of sensors 81 in stator module 200. It will be appreciated that it may not be necessary for all portions of magnetic identifying element 191 to be measured at a single identifying position. At the identifying positions, sensors 81 may be used to read magnetic identifying element 191, in combination with the normal task of identifying mover position.

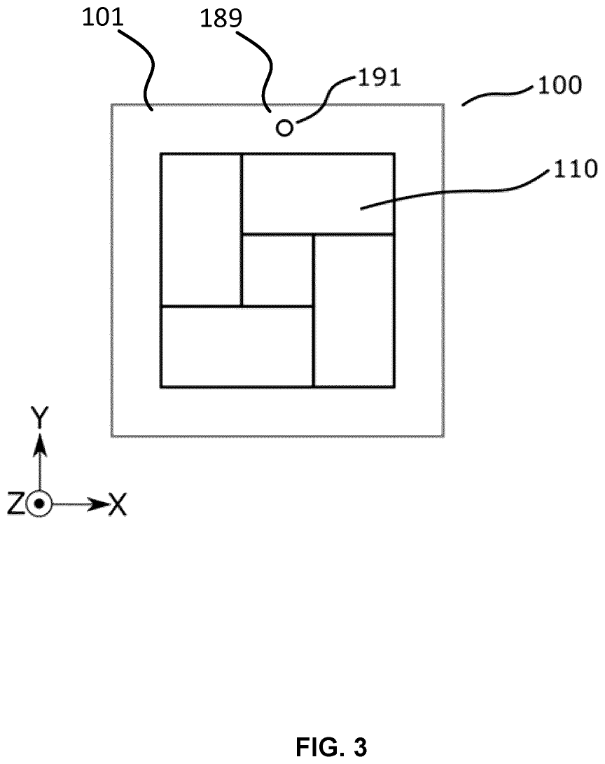

FIG. 3 depicts a top view of mover device 100. As discussed, mover device 100 includes mover 101 and magnetic identifying element 191. Mover 101 includes actuation magnets 110.

Magnetic identifying element 191 may be disposed at reference locations 189 in mover device 101. In particular, mover 101 may define reference locations 189, at which magnetic identifying element 191 may be disposed.

In some embodiments, mover 101 may define only one reference location 189. In other embodiments, mover 101 may define a plurality of reference locations 189 (collectively referred to as reference locations 189).

For example, magnetic identifying element 191 may be disposed at an edge of mover 101, at reference location 189.

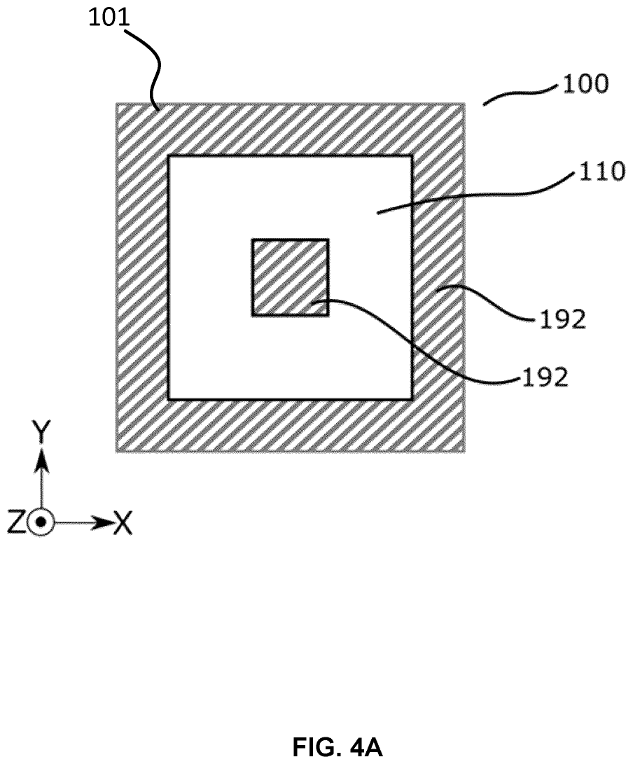

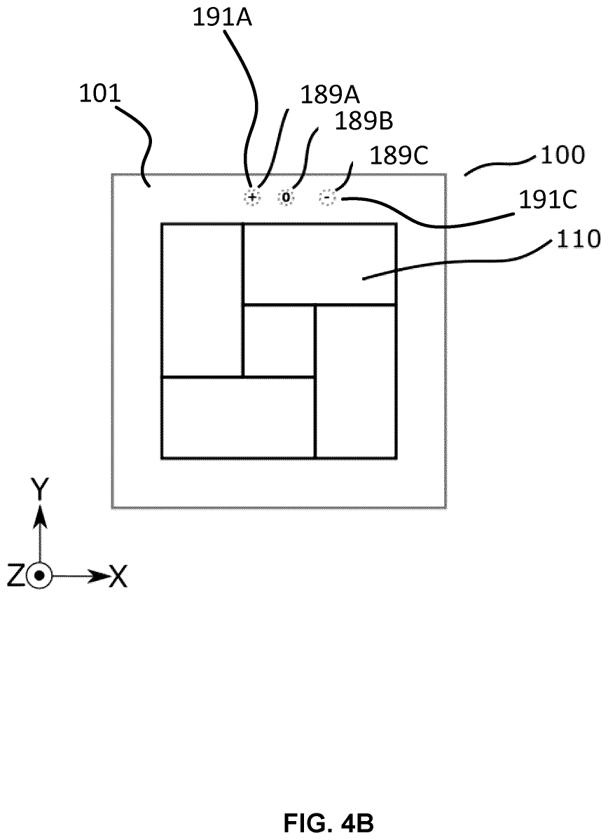

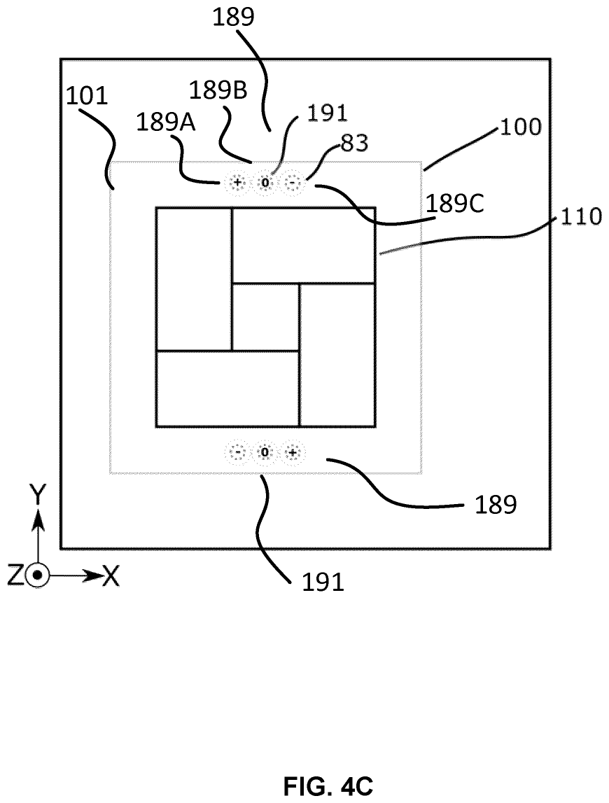

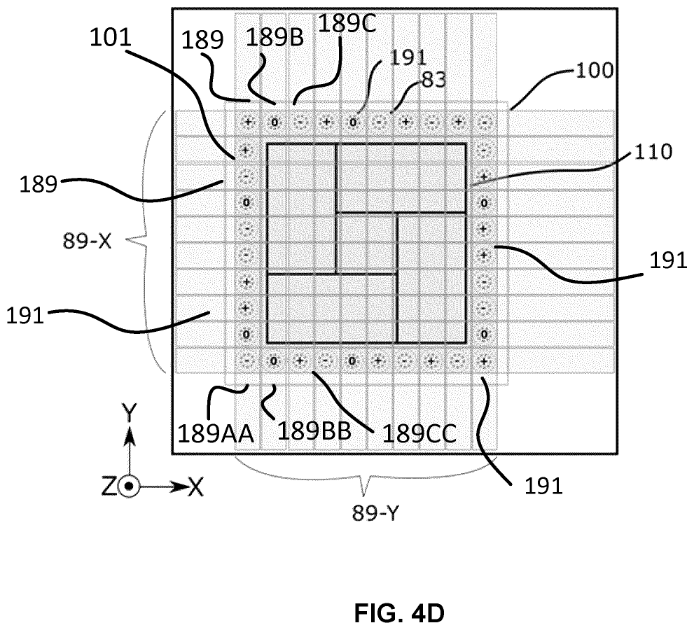

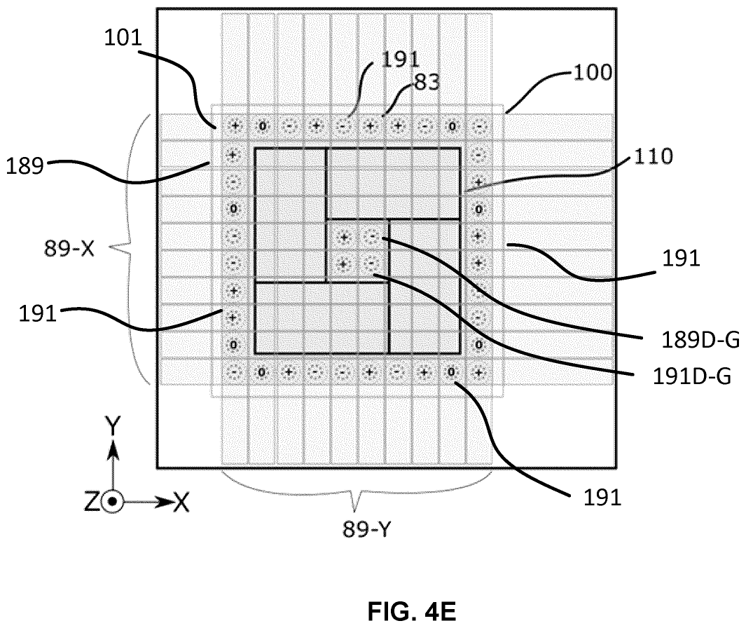

Alternatively, magnetic identifying element 191 may be disposed in other potential areas 192 within mover 101, as depicted in FIG. 4A. Potential areas 192 may be defined by the availability of reference locations 189. For example, mover 101 may only include reference locations 189 at certain areas of mover 101.

It may be desirable for potential areas 192 to avoid vertical overlap with actuation magnets 110 in mover 101, since this may prevent unwanted interactions between actuation magnets 110 and magnetic identifying element 191. Vertically overlapping the entirety of an identifying magnet used within magnetic identifying element 191 with one or more of actuation magnets 110 may locally affect the performance of actuation magnets 110 for generating actuating forces. The overlap may also create difficulties in sensing the identifying magnet relative to the magnetic field of the actuation magnet 110. Due to the possibility for negative interactions in many cases, a non-overlapping portion of the identifying magnet used for sensing may be desirable.

However, in some other embodiments, potential areas 192 may vertically overlap with actuation magnets 110, such that actuation magnets 110 and magnetic identifying element 191 may overlap. In such embodiments, controller 300 may compensate for the impact of actuation magnets 110 on magnetic identifying element 191 and/or the impact of magnetic identifying element 191 on actuation magnet 110.

Potential areas 192 for positioning magnetic identifying element 191 may include the center portion of mover 101, which may be created by the arrangement of actuation magnets 110, or along the permitter of mover device 100 (outside the boundaries of actuation magnets 110). Although magnetic elements 191 can be disposed close as touching to actuation magnets 110, a suitable separation between magnetic identifying element 191 and actuation magnets 110 may be used to limit the interference between magnetic identifying element 191 and actuation magnets 110.

Although potential areas 192 for magnetic identifying element 191 are shown separated from actuation magnets 110, in some embodiments it may be possible to position magnetic identifying element 191 to be touching actuation magnets 110 or to locate magnetic identifying element 191 internally within actuation magnets 110.

It will be appreciated that potential areas 192 may also depend on the layout of actuation magnets 110 on mover device 100. As will be discussed in further detail below, actuation magnets 110 may be disposed in a variety of different configurations on mover device 100.

FIGS. 4B-4E depict various configurations of magnetic identifying element 191 within mover device 100.

In one embodiment, magnetic identifying element 191 includes one or more magnets 191A, 191B, 191C. Magnets 191A, 191B, 191C may also be referred to as identifying magnets. It will be appreciated that magnetic identifying element 191 may include less than or more than three identifying magnets, such as less than or more than the identifying magnets 191A, 191B, 191C. As used throughout this disclosure, magnets 191A, 191B, 191C may refer to one or more magnets, such as only a single magnet or more than three magnets, which form at least a portion of or all of magnetic identifying element 191.

Each of magnets 191A, 191B, 191C may produce a discrete magnet field, such that the magnetic field of magnet 191A is distinct from the magnet field of magnet 191B and distinct from the magnet field of magnet 191C. It will be appreciated that each of magnets 191A, 191B, 191C may produce a magnet field that is capable of being received and identified individually, such that a specific piece of information encoded into each of magnets 191A, 191B, 191C may be measured, identified and used by controller 300 to identify mover device 100.

Magnets 191A, 191B, 191C may be disposed in mover 101 at reference locations 189. For example, each of magnets 191A, 191B, 191C may be disposed at reference locations 189A, 189B, 189C, respectively, in mover 101. It will be understood that mover 101 may include fewer or more reference locations 189 than reference locations 189A, 189B, 189C.

Magnets 191A, 191B, 191C may be configured in one of several possible magnet states at each of reference locations 189A, 189B, 189C, which may be used to encode identification information in magnetic identifying element 191. Magnets 191A, 191B, 191C may have a particular pre-determined pattern in reference locations 189A, 189B, 189C representing identification information. For example, magnets 191A, 191B, 191C may be configured at reference locations 189A, 189B, 189C in one of a positive orientation, negative orientation or neutral orientation, such that the magnetic field of each of 191A, 191B, 191C may have a positive value, negative value or neutral value.

As depicted in FIG. 4B, magnet 191A disposed at reference location 189A may be configured to have a positive value. This may be achieved by orienting the positive or north pole of magnet 191A at reference location 189A away from stator module 200. Similarly, magnet 191C may have a negative value. This may be achieved by orienting the positive or north pole of magnet 191C at reference location 189C towards stator module 200. Thus, magnets with a positive polarity may be oriented in a reverse direction to magnets with a negative polarity.

Alternatively, a positive value may correspond to a magnet oriented with a positive or north pole towards stator module 200, and a negative value may correspond to a magnet oriented with a positive or north pole away from stator module 200.

Reference location 189B may be associated with a neutral value. A neutral value may correspond to a non-magnetic element or the absence of a magnet completely. Thus, magnet 191B may be configured to be absent from mover 101, corresponding to the absence of a magnetic field at reference location 189B.

Although only three different possibilities for values of the magnetic fields of magnets 191A, 191B, 191C are depicted, it will be understood that the positive, negative and neutral orientations of magnets may additionally include varying magnetic field intensities. Magnetic field intensities may be incremented by discrete amounts that are measurable with sensors 81. For example, the strength of the magnetic field measurable by sensors 81 for each of magnets 191A, 191B, 191C may be increased or decreased. This may allow for a greater quantity of positive values and and/or negative values measurable from the magnetic field for a particular magnet. Similarly, the height of the identifying magnets, such as magnets 191A, 191B, 191C, may be varied to create a greater or lesser magnetic field intensity measurable at sensors 81. This may be used to increase the quantity of information stored in magnetic identifying element 191 for a fixed number of magnets 191A, 191B, 191C.

In one example, magnet 191A may have a positive value that is twice the positive value of magnet 191C, such that magnet 191A oriented at reference location 189A indicates a positive value and magnet 191C oriented at reference location 189C indicates a negative value. In a further example, magnet 191A may have a positive value that is twice the positive value of magnet 191C, such that magnet 191A oriented at reference location 189A indicates a 2× positive value and magnet 191C oriented at reference location 189C indicates a 1× positive value, storing different information.

It should be appreciated that the sensitivity of the sensors 81 should be sufficient to distinguish between each of the possible magnetic field values that may be measured for a particular magnet. This will ensure that different positive values and/or negative values may be distinguished from one another by sensors 81 and controller 300.

In some further embodiments, positive, negative and neutral values may correspond to magnets oriented in the same directions but with varying magnetic field strengths. Many possible configurations for positive, negative and neutral values of magnets 191A, 191B, 191C may be possible.

In some further embodiments, positive, negative, and neutral values may correspond to magnets oriented in directions not aligned with the Z-axis, such as in the +X or −X direction, +Y or −Y direction, or in general any direction in 3D space. Sensors 81 may be capable of measuring multiple axes of the magnetic field, such as 2 or 3 axes, to simplify the process of identifying the orientation of magnets 191A, 191B, 191C.

Magnets 191A, 191B, 191C, which are oriented at reference locations 189A, 189B, 189C, are used to store identification information, and in particular the orientation/value and pattern of magnets 191A, 191B, 191C may correspond to specific identification information. The orientation or value of each of magnets 191A, 191B, 191C may correspond to a magnetic “bit”. For example, magnets 191A, 191B, 191C may correspond to the values and pattern (+) (0) (−), which is three bits. Fewer or more bits may be used, corresponding to fewer or more magnets 191A, 191B, 191C. Mover device 100 with identification information (+) (0) (−) may be distinguished by controller 300 from another mover device with identification information being ++0.

It will be appreciated that other bit patterns may be possible. Bit patterns of magnets 191A, 191B, 191C may also be defined by reference locations 189A, 189B, 189C of each of magnets 191A, 191B, 191C on mover 101, which may help controller 300 interpret bit values corresponding to magnets 191A, 191B, 191C. For example, magnets located at reference locations 189 in the corner of mover 101 may indicate either the start or end of a bit pattern for controller 300, or some other portion of the bit pattern.

In some embodiments, magnetic identifying element 191 may be encoded with error checking, error correction, or other mechanisms to detect and/or correct erroneous data read by sensors 81 when interpreted by controller 300. For example, the values and pattern of magnets 191A, 191B, 191C may be encoded with a checksum and/or redundancy.

In some embodiments, the arrangement of magnets 191A, 191B, 191C may follow a pre-determined pattern to identify a specific edge of mover device 100 from other edges.

Although magnetic identifying element 191 is only depicted on one edge in FIG. 4A, it should be understood that any number of edges, corners and the center area may be used for containing magnetic identifying elements.

For example, FIG. 4C depicts magnetic identifying element 191 located on two edges of mover 101. Alternatively, FIG. 4D depicts magnet identifying element 191 located on all four edges of mover 101, while FIG. 4E depicts magnetic identifying element 191 located on all four edges of mover 101 and also in the center of mover 101. It will be appreciated that a variety of configurations and bit patterns in magnetic identifying element 191 may be possible, and may also depend on the configuration of actuation magnets 110.

Controller 300 may be programmed to interpret these bit patterns, which may correspond to the location of magnets in magnetic identifying element 191 on mover device 100. In this way, two mover devices with the same values of magnets, but with the magnets disposed in a different pattern on the mover devices, may thus be distinguishable from one another by controller 300. Controller 300 may look up the bit patterns, including values and locations of magnets, in database 340 to identify and distinguish the mover devices. Controller 300 may also calculate an identity value by following a pre-determined identity calculation process based on the value of magnetic identifying element 191 for specific reference locations 189.

In addition to magnetic identifying element 191 and actuation magnets 110 on mover device 100, FIG. 4C also depicts a strategy for aligning magnets in magnetic identifying element 191, such as magnets 191A, 191B, 191C. For example, magnets 191A, 191B, 191C may be disposed on mover 101 to generally align with the pattern of sensors 81.

As mover device 100 passes across sensors 81, identification information stored in magnetic identifying element 191 may be read by sensors 81. This may occur while mover device 100 is moving or stationary, and either levitating or landed on working surface 202. During identification, each individual sensor 81 may have a respective measurement range 83, within which the individual sensor 81 may be able to reliably identify and distinguish between the magnetic fields associated with each of magnets 191A, 191B, 191C at respective reference locations 189. This may allow each sensor 81 to identify a discrete value associated with the magnetic field of each of magnets 191A, 191B, 191C at reference locations 189A, 189B, 189C, respectively. It will be appreciated that measurement range 83 for each sensor 81 may be affected by the type of magnet used in magnetic identifying element 191 of mover device 100 (i.e. intensity, dimensions, orientation of magnets 191A, 191B, 191C). Additionally, measurement range 83 for sensor 81 may vary depending on the vertical distance between magnetic identifying element 191 and magnets 191A, 191B, 191C and sensor 81.

As well, magnets 191A, 191B, 191C (collectively, all magnets on mover device 100) may be disposed on mover 101 to fit within a measurement range 83 for sensors 81. Disposing magnets 191A, 191B, 191C within measurement range 83 may allow each of magnets 191A, 191B, 191C to be measured individually and distinctly at each of reference locations 189A, 189B, 189C, such that the discrete magnetic field associated with each magnet may be measured to determine the corresponding bit value of that magnet.

In particular, magnetic identifying element 191 may include at least two magnets. At least one of the size and arrangement of the at least two magnets on mover device 100 may allow at least one sensor 81 to measure a magnetic field associated with only one of the at least two magnets at a time.

In addition to the strategies discussed above for aligning magnetic identifying element 191 on mover device 100, FIG. 4D also depicts a further strategy for arranging specific magnets in magnetic identifying element 191.

To be uniquely identifiable, each mover device 100 may have its own pattern of magnets 191A, 191B, 191C in magnetic identifying element 191. This may pose some challenges, since the position of mover device 100 is also identified with the one or more magnetic fields of actuation magnets 110. By allowing only certain magnet patterns and combinations for magnetic identifying element 191, it may be possible to reduce or eliminate the overall effect of magnetic identifying element 191 on performance. Similarly, arranging magnetic identifying element 191 and magnets 191A, 191B, 191C to align with sensors 81 can be used to reduce the impact on performance. For example, a pattern for magnetic identifying element 191 may be selected to have a consistent and small effect on position sensing of mover device 100. Such an effect may be compensated for by, for example, stator module 200 or controller 300.

As depicted in FIG. 4D, magnets 191 may be disposed around the perimeter of mover 101. For example, magnets 191 may be disposed at reference locations 189, wherein at least some of reference locations 189 are in a periphery of mover 101 surrounding actuation magnets 110.

Magnets 191 may also be arranged to fit within at least one row 89-X of reference locations 189 and at least one column 89-Y of reference locations 189 on mover 101. Magnets 191 may be disposed such that the sum of the magnetic fields associated with each row 89-X and each column 89-Y sum to zero. In other words, the magnetic fields of any magnets in each of the at least one column 89-Y and each of the at least one row 89-X may counteract each other when combined together, as detected by the sensor or sensors 81. Alternatively, the sum of the magnetic fields may only be close to zero, i.e. the magnetic fields may not completely counteract each other. In other words, the sum of the bit values of all magnets in identifying element 191 in each row 89-X and each column 89-Y may be zero or close to zero.

In such an embodiment, if a balanced group (e.g. balanced pair in row 89-X and/or column 89-Y) aligns with the locations of sensors 81, the translation motion of mover device 100 can result in a matching increase or decrease in magnetic field strength of the magnetic identifying element 191, measured by the respective sensor 81.

For example, if a column 89-B contains reference location 189B and reference location 189BB, the sum of the values or bits associated with those reference locations 189B, 189BB may be zero. Reference location 189B may correspond to a neutral value, and reference location 189BB may also correspond to a neutral value, such that the total sum of that column 89-B is 0+0=0.

In another example, column 89-C may contain reference location 189C and reference location 189CC, which respectively correspond to values − and +, such that the total sum of that column 89-C is (−)+(+)=0.

In the case of rows 89-X and/or columns 89-Y which contain only two reference locations 189, the magnets disposed at those reference locations 189 may be oriented on mover 101 to form balanced pairs (e.g. if one side is + the other is −, or both are 0, etc.).

In a further example, column 89-A may contain more than two reference locations 189, such as ten reference locations 189. The total sum of that column 89-A is still (+)+(+)+(−)+0+(−)+(−)+(+)+(+)+0+(−)=0.

Although not depicted, such a sum cancellation may also be achieved with identifying magnets with varying magnitudes. For example, a magnet with a 2× positive value can be cancelled by two magnets, each with a 1× negative value: (2+)+(−)+(−)=0.

It will be appreciated that the polarity of the magnet disposed at the first reference location 189 in a row 89-X may be the opposite polarity of the magnet disposed at the last reference location 189 in that row 89-X. Similarly, the polarity of the magnet disposed at the first reference location 189 in a column 89-Y may be the opposite polarity of magnet disposed at the last reference location 189 in that column 89-Y. In these situations, the strengths of the magnets at the first and last reference locations 189 may be the same (just with opposite polarities).

In some embodiments, it may be advantageous to arrange some of either of rows 89-X or columns 89-Y to be symmetrically balanced. For example, if a row 89-X includes ten reference locations 189, the first five reference locations 189 may symmetrically complement the last five reference locations 189 to achieve a total sum of zero, e.g., (+)+(+)+(−)+(−)+0+0+(+)+(+)+(−)+(−)=0. That is, reference location 189 on mover 101 may include magnets oriented in a symmetrical pattern on mover 101.

In some embodiments, either of rows 89-X or columns 89-Y may be arranged to be mirror-symmetric. For example, the reference locations could have the pattern (+) (+) (−) (−) (+) (+). With such an arrangement, the interaction between magnets 191 and coils carrying current imparts no net torque on mover device 100.

It will be appreciated that the reference locations 189 of row 89-X may be arranged in a continuous line, wherein the polarity of two of three magnets in row 89-X may be different. Using the example above with reference locations 189 (+)+(+)+(−)+(−)+0+0+(+)+(+)+(−)+(−), it will be understood that the polarity between successive or contiguous reference locations 189 may flip.

It will be appreciated that the arrangements listed above, as well as other arrangements, may be combined.

The spacing (pitch) between reference locations 189A, 189B, 189C, 189AA, 189BB, 189CC in rows 89-X may be kept consistent, such that the spacing between magnets oriented in those reference locations 189A, 189B, 189C, 189AA, 189BB, 189CC is also kept consistent. As well, the spacing between reference locations 189A, 189B, 189C, 189AA, 189BB, 189CC in columns 89-Y may also be kept consistent, such that the spacing between magnets oriented in those reference locations 189A, 189B, 189C, 189AA, 189BB, 189CC is also kept consistent. The spacing between reference locations 189 in rows 89-X and columns 89-Y may also be the same, such that the spacing between individual rows 89-X and columns 89-Y is the same.

In some embodiments, magnets may be disposed in a symmetrical pattern on mover 101. In an alternate embodiment, magnetic fields from magnets in magnetic identifying element 191 may be rotationally asymmetric about an axis surrounded by the magnets in magnetic identifying element 191, where actuation magnet 110 may be rotationally symmetric about this axis for some particular embodiments.

It will be appreciated that although magnets within magnetic identifying element 191 may be selected and disposed to result in at least one row 89-X and/or at least one column 89-Y with magnetic fields that sum to zero, magnetic identifying element 191 may still be encoded with identification information. Sensors 81 may still detect values from the discrete magnetic fields corresponding to reference locations 189A, 189B, 189C, 189AA, 189BB, 189CC and controller 300 may decode identification information stored in magnetic identifying element 191 from those detected values.

FIG. 4E depicts a further example of this strategy for arranging specific magnets in magnetic identifying element 191. In particular, magnets 191D-G in magnetic identifying element 191 may be located at reference locations 189D-G in the center of mover 101. As depicted, reference locations 189D-G include up to four magnets 191D-G, but in other embodiments may contain fewer or more reference locations 189 and/or magnets 191D-G.

Reference locations 189D-G may also be arranged in rows 89-X and columns 89-Y with magnets on the perimeter or periphery of mover 101. As previously discussed, at least one of rows 89-X and/or at least one of columns 89-Y may sum to zero.

In addition, the orientation of magnets 191D-G disposed at reference locations 189D-G may also be selected to sum to zero in the center of mover 101. For example, the values corresponding to reference locations 189D-G may be (+)+(+)+(−)+(−)=0.

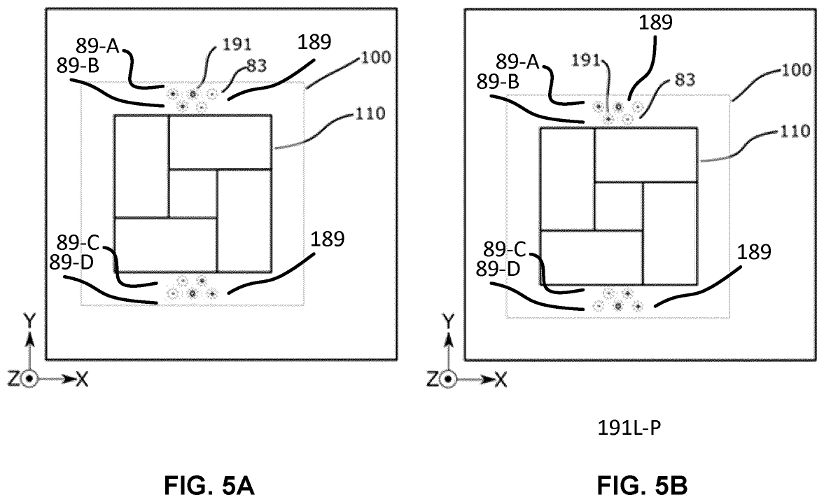

FIGS. 5A-5B depict a further example of mover device 100 and magnetic identifying element 191 arranged along multiple edges of mover 101. FIG. 5A depicts mover device 100 at a first time period, while FIG. 5B depicts mover device 100 at a second time period.

In some situations, a particular arrangement of magnets in magnetic identifying element 191 may not have any positions where a sufficient quantity of sensors 81 adequately align with all of the magnets in magnetic identifying element 191. This may prevent the measurement of all the magnetic fields associated with those magnets by sensors 81 and the determination of the corresponding values associated with all those magnets in magnetic identifying element 191. In these situations, magnetic identifying element 191 may include at least two magnets. At least one of the size and the arrangement of the at least two magnets on mover device 100 may restrict sensor 81 to measure one or more magnetic fields associated with only some of the magnets at a time. For example, only one magnet may be within measurement range 83 for sensor 81 at a time. In some embodiments, the density of identifying magnets within magnetic identifying element 191 may exceed the density of sensors 81 in a local area.

In such situations, controller 300 may be configured to identify mover device 100 based on multiple measurements of the magnetic fields associated with the magnets. The measurements may be collected over a plurality of times.

For example, at least one sensor 81 may be configured to measure at least one magnetic field associated with magnetic identifying element 191 at a plurality of times. Controller 300 may be configured to identify mover device 100 based on those measurements.

In addition, the measurements may be performed by multiple sensors 81 in stator module 200 when mover device 100 is at multiple different locations of working surface 202.

For example, at first time period depicted in FIG. 5A, a first group of reference locations 189 in rows 89-A, 89-D are positioned to align with sensor 81 within measurement range 83 at a first identifying position.

At a second time period depicted in FIG. 5B, a second group of reference locations 189 in rows 89-B, 89-C are positioned to align with sensor 81 within measurement range 83 at a second identifying position.

By combining the measured values of rows 89-A, 89-D measured at a first identifying position at a first time period and the measured values of rows 89-B, 89-C measured at a second identifying position at a second time period, identification information stored in magnetic identifying element 191 can be determined.

It will be appreciated that more than two identifying positions and/or more than two time periods may be required.

Controller 300 may be configured to combine values measured by sensors 81 from several identifying positions and/or several times to determine the overall identification information stored in magnetic identifying element 191.

As well, in some situations the same magnet may be measured multiple times. Controller 300 may be configured to determine when the same magnet is measured multiple times and exclude the additional measurements. Controller 300 may determine this using a variety of different methods, such as using error correction data encoded into magnetic identifying element 191 and the pattern of bits.

In some embodiments, controller 300 may use the prior measurement of one of identifying magnets in magnetic identifying element 191 to assist with determining future bits, such as when sensor 81 is partially measuring multiple identifying magnets.

In some further embodiments, controller 300 may be configured to identify mover device 100 without measuring all of magnets in magnetic identifying element 191, such that only a portion of magnets being measured by sensors 81 may be sufficient to allow controller 300 to identify mover device 100 and/or distinguish mover device 100 from other movers.

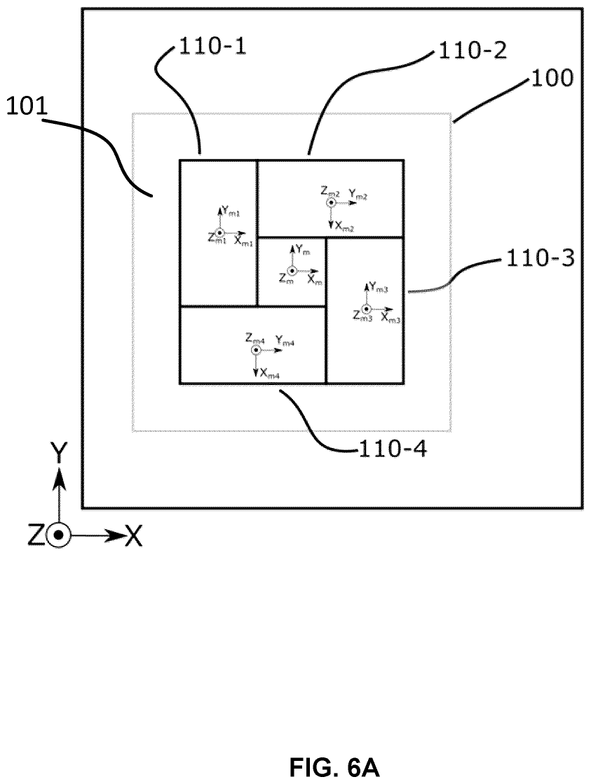

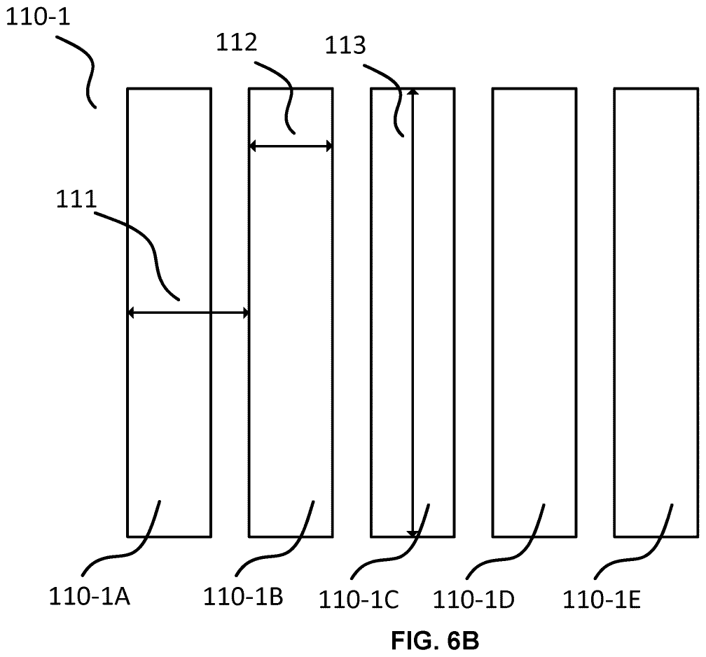

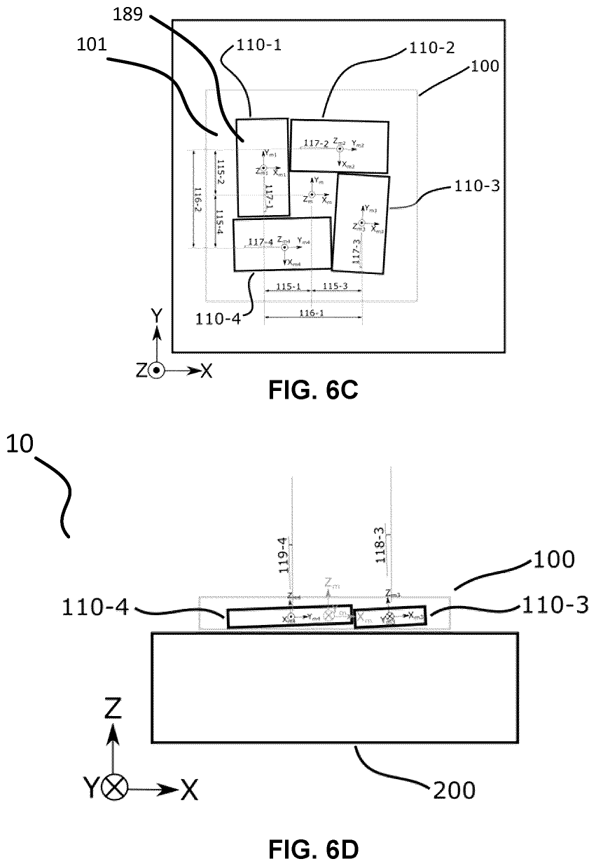

FIGS. 6A-6D depict configurations of actuation magnets 110 on mover 101. In particular, actuation magnets 110 may include magnet arrays 110-1, 110-2, 110-3, 110-4. In other embodiments, actuation magnets 110 may include fewer or more magnets arrays. Magnet arrays 110-1, 110-2, 110-3, 110-4 may each include a collection of one or more smaller magnets for responding to external magnetic fields generated by stator module 200.

A pair of coordinate systems may be defined to help explain the movement of mover device 100 (including mover 101) relative to stator module 200. In particular, a stator coordinate system may be defined, which is fixed to stator module 200. A mover coordinate system may also be defined, which is fixed to mover device 100 and moves with mover device 100 relative to stator module 200 and the stator coordinate system. Conventional Cartesian coordinates (x, y, z) may be used to describe these coordinate systems, although, it will be appreciated that other coordinate systems could be used. For convenience and brevity, in this description and the associated drawings, the directions (e.g. x, y, z directions) in the stator coordinate system and the directions in the mover coordinate system may be shown and described as being coincident with one another, i.e. the stator-x (or Xs), stator-y (or Ys) and stator-z (or Zs) directions may be shown as coincident with mover-x (or Xm), mover-y (Ym) and mover-z (or Zm) directions, respectively. Accordingly, reference to directions x, y, and/or z may refer to directions in both or either of the stator and mover coordinate systems. However, it will be appreciated from the context herein that in some embodiments and/or circumstances, a mover device 100 may move relative to a stator module 200 such that these stator and mover coordinate systems are no longer coincident with one another. In such cases, the following convention may be adopted: the terms stator-x, stator-y and stator-z may be used to refer to directions and/or coordinates in the stator coordinate system and the terms mover-x, mover-y and mover-z may be used to refer to directions and/or coordinates in the mover coordinate system. The symbols Xm, Ym and Zm may be used to refer respectively to the mover-x, mover-y and mover-z directions, the symbols Xs, Ys and Zs may be used to refer respectively to the stator-x, stator-y and stator-z directions and the symbols X, Y and Z may be used to refer respectively to either or both of the mover-x, mover-y and mover-z and/or stator-x, stator-y and stator-z directions. In some embodiments, during normal operation, the mover-z and stator-z directions are approximately in the same direction (e.g. within ±30° in some embodiments; within ±10° in some embodiments; and within ±2° in some embodiments).

FIG. 6A depicts magnet arrays 110-1, 110-2, 110-3, 110-4 used for actuating mover 101 and thus mover device 110 in at least two degrees of freedom. Each of magnet arrays 110-1, 110-2, 110-3, 110-4 may be considered to have individual magnetic centers (determined by the magnetic field of the array) based on the unique sizing, strength and respective variations of each of magnet arrays 110-1, 110-2, 110-3, 110-4.

It will be appreciated that fewer or more magnet arrays 110-1, 110-2, 110-3, 110-4 than depicted may also be possible.

FIG. 6B depicts an embodiment magnet array 110-1. Magnet array 110-1 may include magnet array elements 110-1A, 110-1B, 110-1C, 110-1D, 110-1E (collectively, magnetic array elements 110-1A-E).

It will be understood that magnet array 110-1 may include fewer or more magnet array elements than depicted.

Magnet array elements 110-1A-E may have a magnetic pitch 111 between neighbouring magnet array elements.

Magnetic array elements 110-1A-E may also have a width 112 and a length 113.

In some embodiments, magnetic array elements 110-1A-E may each having a different magnetization and may have a magnetic pitch 111 that is determined by the distance between peaks of the magnetic field created by the combination of magnetic array elements 110-1A-E of magnetic array 110-1.

In some particular embodiments, the magnetic pitch 111 may not be the same as the physical pitch between one or more individual array elements of the magnet array. The magnetic pitch 111 may be dependent on the particular pattern of magnetic array elements and their respective magnetic orientations.

In further embodiments, one or more of magnetic array elements 110-1A-E may have a different magnetic pitch 111, width 112 and/or length 113 than other magnetic array elements.

Although FIG. 6B depicts magnetic array 110-1 with five elements, it should be understood that fewer or more magnetic array elements may be used to create a similar alternating magnetic field for one of magnet arrays. Additionally, some magnet arrays may use segments with varying individual element widths to create the alternating magnetic field of the magnet array.

As depicted in FIGS. 6C-6D, however, during assembly magnet arrays 110-1, 110-2, 110-3, 110-4 may additionally have some small positional variations relative to each other in locational pitch, height or angle with respect to the X, Y and/or Z axis of mover 101. Although not depicted, magnet arrays 110-1, 110-2, 110-3, 110-4 may also have variations in intensity, size, orientation of magnetization, uniformity of magnetization, and other features which affect the magnetic field generated by each magnet. These variations may be intentionally or unintentionally created (i.e. manufacturing variation).

A magnetic blemish includes a combination of one or more of these variations in magnet arrays 110-1, 110-2, 110-3, 110-4. In some embodiments, the magnetic blemish may be used to differentiate two or more mover devices from each other. This variation may be used instead of or in addition to magnetic identifying element 191 on mover device 100. For example, sensors 81 may determine at least one magnet field of the actuation magnets 110 and/or specific magnet arrays 110-1, 110-2, 110-3, 110-4 and controller 300 may identify mover device 100 based on the at least one magnetic field. These variations may be stored in database 340, which controller 300 may access to identify a mover device and/or distinguish two or more mover devices from one another.

In one particular embodiment, each mover device 100 may be driven to one or more positions where sensors 81 may measure the magnetic field of magnet arrays 110-1, 110-2, 110-3, 110-4. The magnetic field measurements may then be used to calculate the strength, position and angle of each magnet array 110-1, 110-2, 110-3, 110-4 in mover 101. Comparing these parameters against information stored in database 340, can allow mover device 100 to be identified. Similarly, comparing these parameters between multiple mover devices can allow mover devices to be differentiated from each other.

For example, one or more of magnet arrays 110-1, 110-2, 110-3, 110-4 may be located at reference locations 189. Sensors 81 may measure the magnetic field from one or more reference locations 189 associated with one or more of magnet arrays 110-1, 110-2, 110-3, 110-4 and/or magnetic array elements 110-1A, 110-1B, 110-1C, 110-1D, 110-1E, and controller 300 may be configured to identify mover device 100 in response to the measurement by sensors 81.

In some further embodiments, mover devices may be measured to identify their unique variations, and these measurements may occur at the same location or set of locations of the mover devices and/or stator module 200 to make the measurement data more consistent. If a variation in mover 101 makes the corresponding mover device 100 not rotationally symmetric, the orientation of mover device 100 could additionally be identified based on these measured variations.

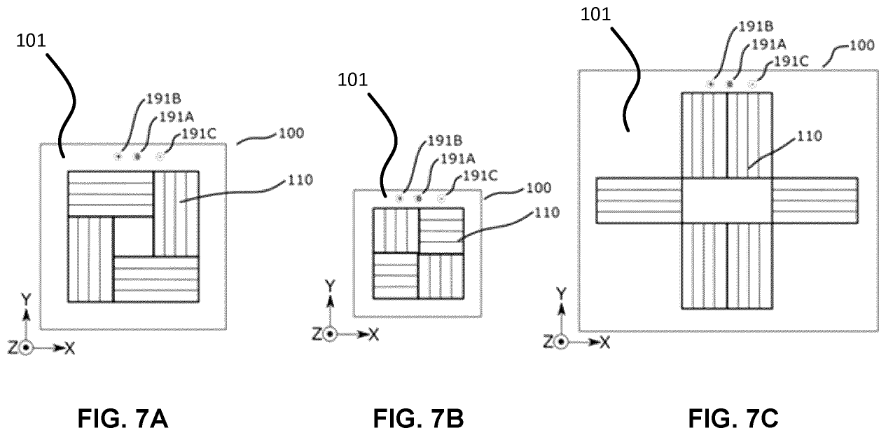

FIGS. 7A-7C depict some further arrangements of actuation magnets 110 on mover device 100. Actuation magnets may be oriented in at least two directions (e.g., X or Y directions) to interact with external magnetic fields generated by stator module 200, and to actuate mover device 100 in at least two degrees of freedom.

Given the specific arrangement of actuation magnets 110, magnetic identifying element 191 may be disposed at positions where the effective portion (used for identification via sensors 81) of magnetic identifying element 191 is not overlapping along the Z axis with actuation magnet 110.

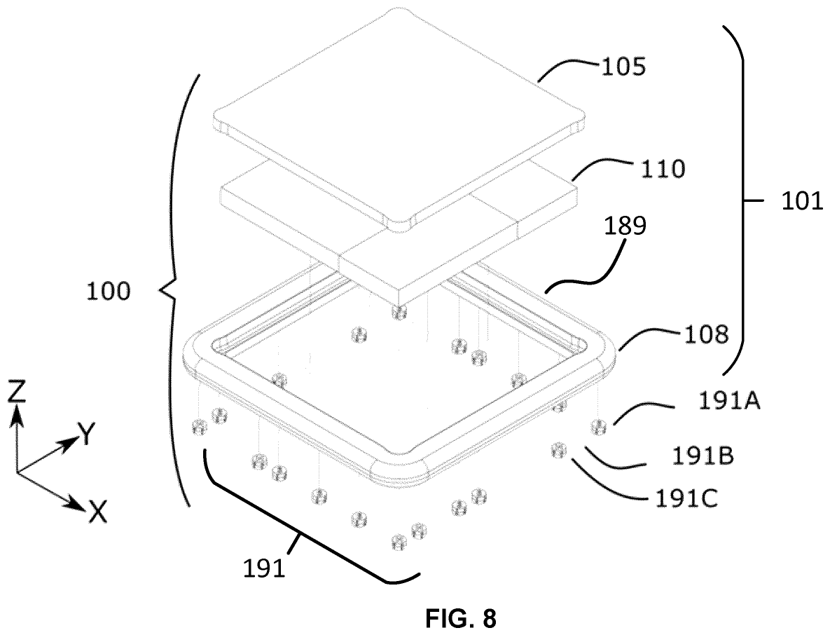

FIG. 8 depicts a perspective view of mover device 100, according to an embodiment. As noted above, mover device 100 includes mover 101 and magnetic identifying element 191. Magnetic identifying element 191 includes magnets 191A, 191B, 191C. Mover 101 includes actuation magnets 110 and may also include top cover 105 and support ring 108.

It will be appreciated that support ring 108 may hold actuation magnet 110 and top cover 105.

Top cover 105 may be used for carrying products, components and/or workpieces, and may further be configured to hold a basket, box or other enclosure device.

Support ring 108 may also enclose magnetic identifying element 191. In particular, magnets 191A, 191B, 191C may be stored within support ring 108 at reference locations 189. In some embodiments, reference locations 189 may be pre-defined within support ring 108.

In some embodiments, support ring 108 and top cover 105 may be created as a single part serving both functions.

In some embodiments, support ring may be opened, such that magnets may be inserted and/or moved around within support ring 108. Support ring 108 may have individual slots for each of magnets 191A, 191B, 191C, corresponding to reference locations 189, and may securely hold magnets 191A, 191B, 191C once support ring 108 is closed.

Support ring 108 may be open at the bottom center to allow more direct exposure of actuation magnets 110 to external magnet fields generated by stator module 200 and sensors 81.

In some further embodiments, support ring 108 may also be opened around the bottom perimeter to allow more direct exposure of magnetic identifying element 191 to sensors 81.

Support ring 108 may be a square, circle, rectangle, triangle or any other shape or polygon. Support ring 108 may also have additional dimensions, such that support ring 108 is a cube, rectangular or triangular prism, a sphere or some other three-dimensional shape.

A user of mover device 100 may vary the arrangement of magnets in magnetic identifying element 191 to encode a particular identification value. For example, a user may disassemble support ring 108 and re-arrange, add or remove magnets to encode new identification information in magnetic identifying element 191.

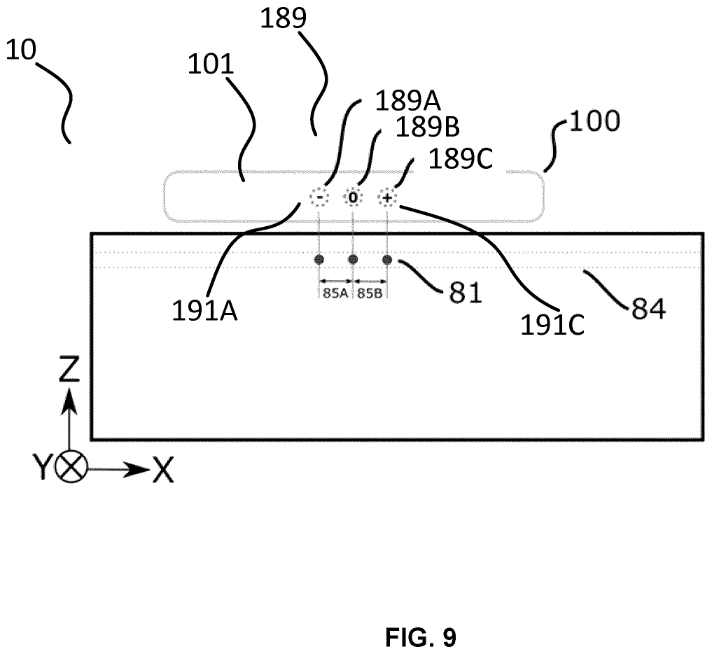

FIG. 9 depicts a further detailed view of displacement system 10, depicting the vertical alignment of magnets 191A, 191C in magnetic identifying element 191 over sensors 81 at an identifying location/position. Magnets 191A, 191C are oriented at reference locations 189A, 189C. Another reference location 189B may not contain any magnet. As discussed, magnets 191A, 191C may include one or more permanent magnets, with each magnet oriented in a certain direction/polarity towards sensors 81 to allow for detection by sensors 81. Magnet orientations may be selected to generate a maximum measurable strength by sensors 81 element and to be relatively insensitive to position. For example, and as already discussed, magnets may be selected with the magnetic south and/or north directed in the −Z direction towards the sensors 81.

In one particular example, reference locations 189A, 189B, 189C may have multiple potential values used for identification. For example, reference location 189B may have a neutral value. In this example, magnet 191B may be omitted from mover 101 to produce a neutral value at reference location 189B. Other orientations depicted at reference locations 189A, 189C may include a magnet with south oriented towards sensor 81 or a magnet with north oriented towards sensor 81, a magnet that is around double the normal strength with north oriented towards sensor 81, or a magnet that is around double the normal strength with south oriented towards the sensor 81. It will be appreciated that other orientations and magnet strengths/intensities are possible.

In another embodiment, the vertical position of a magnet in magnetic identifying element 191 may be varied by a discrete amount so that sensors 81 may measure a greater or lesser value at the same vertical height for mover device 100 at a given identifying location. For example, magnet 191A at reference location 189A may be disposed close to the upper surface of mover 101. Using the variable magnetic height in mover device 100 may provide a greater number of identification combinations without increasing or decreasing the magnetic strength of magnets 191A, 191C in magnetic identifying element 191.

Although in some embodiments, mover device 100 may fully align all of reference locations 189A, 189B, 189C and/or magnets 191A, 191C with a subset of sensors 81 simultaneously, this may not be necessary. It should also be understood that partial or complete subsets of identifying data or measurements from sensors 81 may be obtained and combined together by controller 300.

In some embodiments, it will be possible to read some or all of reference locations 189A, 189B, 189C simultaneously for a plurality of mover devices at several possible identifying locations.

In some embodiments, a dedicated subset of sensors 81 may be used for measuring magnetic identifying element 191 and mover identification. In other embodiments, the same sensors 81 may be used for both identification of mover device 100 and position identification of mover device 100, i.e. the same sensors may measure magnetic identifying element 191 and mover device 100 position.

Mover device 100 position may be obtained by measuring actuation magnets 110 and/or portions or all of magnetic identifying element 191.

In some particular cases, mover device 100 being identified at an identifying location may land or move to a lower levitation height to reduce the distance between magnetic identifying element 191 being read and sensors 81 being used for measurement. The position of mover device 100 during identification may additionally be chosen to ensure all reference locations 189A, 189B, 189C and magnets 191A, 191C being read are positioned close to the centers of the measurement range 83 for each sensor 81 being used for identification.

Sensor 81 may have sensor spacing (or pitch), 85A, 85B. Sensor spacing 85A and sensor spacing 85B may be the same or different, such that multiple different sensor spacings may be used throughout stator module 200. Sensor spacing 85A, 85B may be unequal for some embodiments affecting the individual measurement ranges for identifying element 191 of mover device 100. Sensor 81 may follow a non-uniform pattern in some cases or a pattern that does not align to the X and Y directions of stator module 200. In some cases, identifying element 191 may be similarly varied to allow three or more reference locations 189A, 189B, 189C to maintain alignment with sensor 81 at an identifying position.

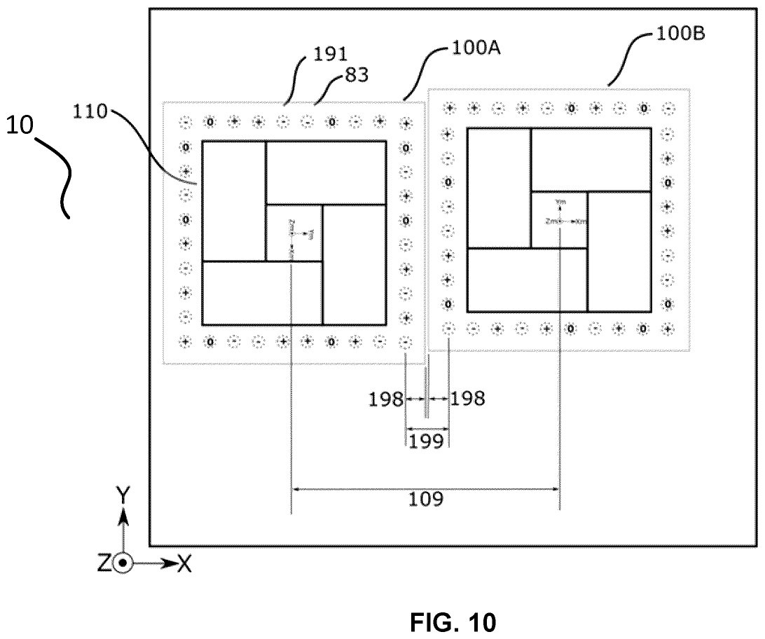

FIG. 10 depicts two mover devices 100A, 100B, each including a uniquely encoded magnetic identifying element. When mover devices 100A, 100B are positioned in close proximity to each other, the large forces generated between the magnetic identifying elements of each mover device may be undesirable. In some cases, these large forces could generate undesirable motion for a deactivated mover device (i.e., not levitating or moving), since compensating forces are not being generated by stator module 200. As well, these large forces could generate a disturbance force on the motion of mover devices 100A, 100B, potentially resulting in unplanned motion or vibrations.

However, two mover devices 100A, 100B operating in close proximity typically can operate with an inter-mover pitch 109, which is limited by the width of each mover device and may include a small clearance/tolerance value. When operating in close proximity, the magnetic distance 199 between magnetic identifying elements of mover devices 100A, 100B may be selected to be sufficiently large. Magnetic identifying element may also be configured with a certain edge distance 198 from the edge of the mover device.

In some particular cases, the edge of magnetic identifying element will be kept at least one millimeter from the outer sides of the mover device. The distance may depend on the strength of the magnets in magnetic identifying element and/or the strength of actuation magnets on mover device.

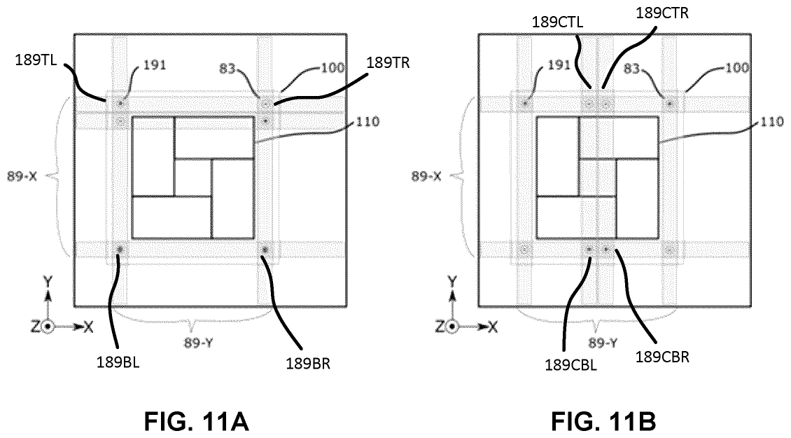

FIG. 11A depicts mover device 100 further configured for orientation detection relative to working surface 202. In particular, magnetic identifying element 191 may be disposed upon mover 101 such that the orientation of mover device 100 may be determined based on which reference locations 189 and the corresponding magnets of magnetic identifying element 191 are detected by sensors 81. In particular, controller 300 may correlate which sensor 81 detected which reference location 189 and the corresponding magnet in magnetic identifying element 191, to determine the orientation of mover device 100.

A subset of reference locations 189TL, 189TR, 189BL, 189BR may be disposed on mover 101 for determining the orientation of mover device 100 relative to working surface 202 and stator module 200. In some cases, actuation magnets 110 may appear to sensors 81 as identical in multiple rotation locations, i.e. rotationally symmetric. Thus, the arrangement of reference locations 189TL, 189TR, 189BL, 189BR may allow a specific location, such as an edge or corner of mover device 100, to become identifiable from other parts of mover device 100, enabling identification of the orientation of mover device 100.

It will also be appreciated that reference locations 189TL, 189TR, 189BL, 189BR may allow for the identification of the position of mover device 100 on working surface 202. In particular, although sensors 81 may detect the location of mover device 100 based on actuation magnets 110, controller 300 may improve this position detection with orientation information or just with reference locations 189TL, 189TR, 189BL, 189BR.

For example, reference 189TL may indicate the top left corner of mover device 100, while reference 189TR may indicate the top right corner. Reference locations 189TL, 189TR may each include a magnet from magnetic identifying element 191 oriented with a certain value, or a magnet may be absent at those reference locations 189TL, 189TR. Similarly, magnet 189BL may indicate the bottom left corner of mover device 100, while magnet 189BR may indicate the bottom right corner. Reference locations 189BL, 189BR may each include a magnet from magnetic identifying element 191 oriented with a certain value, or a magnet may be absent at those reference locations 189BL, 189BR. A specific sensor 81 measuring reference location 189TL, for example, may allow controller 300 to determine the orientation of mover device 100.

Fewer or more reference locations may be used for identifying the orientation of mover device 100. For example, only one reference location, such as reference location 189TL, may be used for identifying the orientation of mover device 100 once it is measured by one of sensors 81. However, it will be appreciated that rows 89-X and columns 89-Y may sum to zero if more reference locations are used, such as one on each corner. As well, more reference locations used for orientation detection may increase the probability that the orientation of mover device 100 can be detected at any one time, since the probability that one or more of reference locations 189TL, 189TR, 189BL, 189BR are overlapping with one or more sensors 81 may be increased.

In further embodiments, reference locations may also be used in the center of mover device, as depicted in FIG. 11B. For example, in addition to reference locations 189TL, 189TR, 189BL, 189BR, reference locations 189CTL, 189CTR, 189CBL, 189CBR may also be used. Reference location 191CTL may indicate the top left center of mover device 100, while reference location 191CTR may indicate the top right center. Similarly, reference location 189CBL may indicate the bottom left center of mover device 100, while reference location 189CBR may indicate the bottom right center. Reference locations 189CTL, 189CTR, 189CBL, 189CBR may each include a magnet from magnetic identifying element 191 oriented with a certain value, or a magnet may be absent at those reference locations 189CTL, 189CTR, 189CBL, 189CBR.

Although magnetic identifying element 191 for identifying specific positions may be fixed in value to determine the orientation of mover device 100 relative to stator module 200, some other embodiments may utilize the value of a particular region of magnetic identifying element 191 to identify orientation. For example, an encoding method could assign a number to each edge of mover device 100 using the pattern of bits (i.e. magnetic field values) on that edge, and the edge with highest or lowest number may be utilized to determine the orientation of mover device 100 relative to working surface 202.

It will be appreciated that mechanical tolerances may prevent magnets and/or the magnetic fields associated with those magnets in magnetic identifying element 191 from perfectly lining up with sensors 81, or from being perfectly spaced within the pattern of magnetic identifying element 191 on mover device 100.

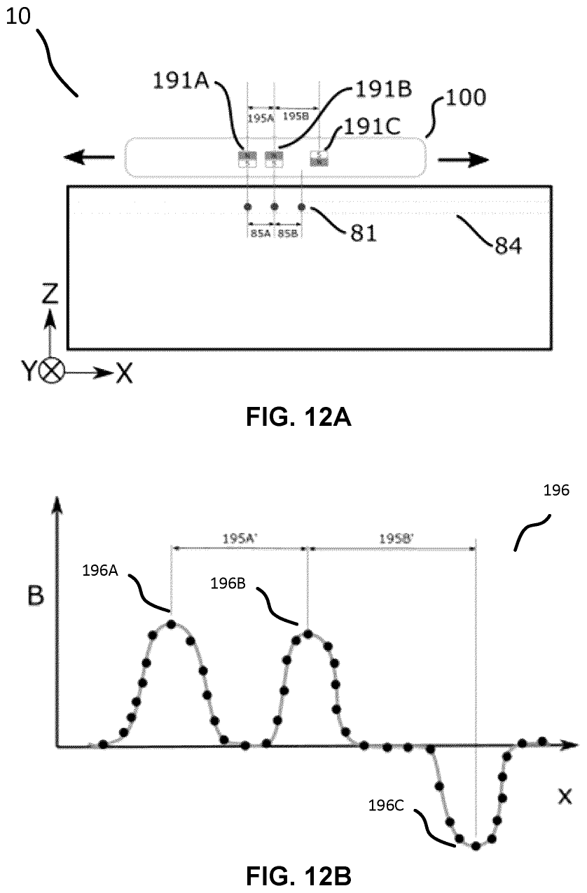

For example, as depicted in FIG. 12A, magnets 191A and 191B may line up with sensors 81. The sensor spacing (or pitch) 85A between sensors 81 may be the same as the magnet spacing (or magnetic pitch) 195A used between magnets 191A and 191B. However, magnet spacing 195B between magnet 191B and 191C may be greater than sensor spacing 85B, such that magnet 191C will not line up with sensors 81 while magnets 191A and 191B line up with sensors 81. Thus, magnet 191C may not be accurately measured by sensors 81, such that the measured magnetic field strength of magnet 191C may be less than its peak value.

Magnet 191C may only line up with sensors 81 when mover device 100 is shifted by the difference between magnet spacing 195B and sensor spacing 85B, such that magnet 191C lines up with sensor 81. In some embodiments, the difference between magnet spacing 195B and sensor spacing 85B may be approximately 1 millimeter (mm), although this value may be greater than or less than 1 mm and may depend on the mechanical tolerances.

In some embodiments, this offset of magnet 191C from magnets 191A, 191B may be inadvertent and due to manufacturing variability. In one example, manufacturing variability may cause reference locations 189 to be inconsistently spaced apart.

However, in other embodiments, this variability may be intentionally used to create more identity permutations for identification information encoded into magnetic identifying element 191. This may be accomplished by varying the spacing between reference locations 189. For example, if magnet 191C in magnetic identifying element 191 is shifted in a particular direction (e.g. in X or Y) by a measurement amount (e.g. 1 mm), as depicted in FIG. 12A, the two possible positions of magnet 191C (before the 1 mm shift and after) may create multiple possible variations between the two arrangements of the magnet without requiring an increase in the number of magnets in magnetic identifying element 191. This could be used to increase the maximum possible number of identity permutations for a fixed quantity of magnets.

FIG. 12B depicts a magnetic field strength curve 196 generated by measuring magnetic fields at the same sensor 81 across a variety of different X positions of mover device 100. In magnetic field strength curve 196, the magnetic field strength B measured by a particular sensor 81 may vary depending on the location X of mover device 100. At a first magnetic field strength peak 196A, sensor 81 may measure magnet 191A at a first position in the X direction. At this first peak 196A, sensor 81 may be perfectly aligned with magnet 191A, such that the maximum magnetic field strength of magnet 196A may be measured by sensor 81. As mover device 100 shifts in the X direction, the strength of the magnet field associated with magnet 191A may diminish as magnet 191A moves away from sensor 81. However, as magnet 191B approaches the vicinity of sensor 81, sensor 81 may begin to measure the magnet field of magnet 191B, which may grow in magnetic field strength as magnet 191B and sensor 81 grow closer until sensor 81 measures second peak 196B. Since magnet spacing 195A may be the same as sensor spacing 85A, the magnetic field strength peak spacing 195A′ between first peak 196A and second peak 196B may be the same.

Eventually, magnet 191B may move away from sensor 81 in the X direction and the magnetic field strength of magnet 191B measured by sensor 81 may diminish. However, since magnet spacing 195B between magnet 191C and 191C may be different than magnet spacing 195A, mover device 100 may need to shift a different quantity in the X direction until sensor 81 can measure third magnetic field strength peak 196C associated with mover 195C. As depicted, the magnetic field strength peak spacing 195B′ between second peak 196B and third peak 196C may be greater than peak spacing 195A′.

Sensor spacing 85A and 85B may also be equal in some cases. It should be understood that by combining multiple measurements of sensor 81, any combination of different sensor spacings 85A, 85B and inter-identifying magnet spacings 195A, 195B may be measured with an adequate range of measurement locations. Magnet spacing 195A, 195B may match any or none of sensor spacings 85A, 85B.

In one embodiment, additional information may be stored in magnetic field strength peak spacing 195A′ and magnetic field strength peak spacing 195B′ between magnets 191A, 191B, 191C, in addition to the values of those magnets measured by sensors 81. It will be appreciated that the values of magnets 191A, 191B, 191C may correspond to magnetic field strength peaks 196A, 196B, 196C, respectively.

In particular, mover device 100 may be identified by identifying at least one peak magnetic field strength of at least one magnetic field measured by one or more sensors 81. At least two measurements may be obtained. For example, the first measurement may describe at least one magnetic field measured at a first position of mover device 100 and the second measurement may describe at least one magnetic field measured at a second position of mover device 100. The at least one peak magnetic field strength may be determined from the at least two measurements. Mover device 100 may be identified based on the at least one peak magnetic field strength.

Mover device 100 may also be identified based on other information associated with the at least one peak magnetic field strength, such as the spacing between multiple peak magnetic field strengths. In one example, additional information could be determined from peak spacing 195A′ and peak spacing 195B′, i.e. the differences in spacing between magnets 191A, 191B, 191C that is measurable by sensors 81.

Configuring one or more sensors 81 to scan the magnetic field strength at a variety of different positions of mover device 100 may allow controller 300 to generate magnetic field strength curve 196. Magnet field strength curve 196 may include a dense set of points, which may provide additional data which can be used to do the following: to detect a peak which may be slightly off-center due to limitations in manufacturing tolerances; to detect the X position of the peak, with data encoded in the X position, so as to increase the amount of data that can be stored with the same number of magnets; to allow further digital or analog processing or filtering of the scanned data; and to provide robustness.

These processing steps may further include low-pass filtering to reject sensor noise, high-pass filtering to reject a common-mode signal (which may be caused by, for example, the actuation magnets 110), and band-pass filtering to accomplish both of these objectives.

These techniques may generalize to scanning in 2D and 3D, with similar generalized benefits. Benefits may include detecting peaks which may be off-center in Y and/or Z, as well as X; detecting the Y position of the peak, again so that more data can be encoded in magnetic identifying element 191; and to allow for more advanced filtering algorithms that accept 2D or 3D data.

In some embodiments, scanning mover device 100 may utilize Z motion relative to the sensors 81 for identification of magnets in magnetic identifying element 191. The magnetic field of a permanent magnet may decrease based on the distance between the magnet and sensor 81, as depicted in FIG. 12A. By using multiple sensor measurements at different vertical positions of mover device 100, the varying intensity of the magnets in magnetic identifying element 191 and actuation magnets 110 can be isolated from any static measurement offsets. In some particular cases, the value of a magnet in magnetic identifying element 191 may be determined by subtracting the magnet value measured at a high mover device 100 levitation height from the magnet value measured at a low mover device 100 levitation height (at the same or very similar X-Y position).

It will be appreciated that magnet spacing (or magnetic pitch) 195A between magnets 191A and 191B may be different than the magnetic pitch 111 between magnetic array elements in actuation magnets 110, such as pitch 111 between magnetic array elements 110-1A, 110-1B, 110-1C, 110-1D, 110-1E.

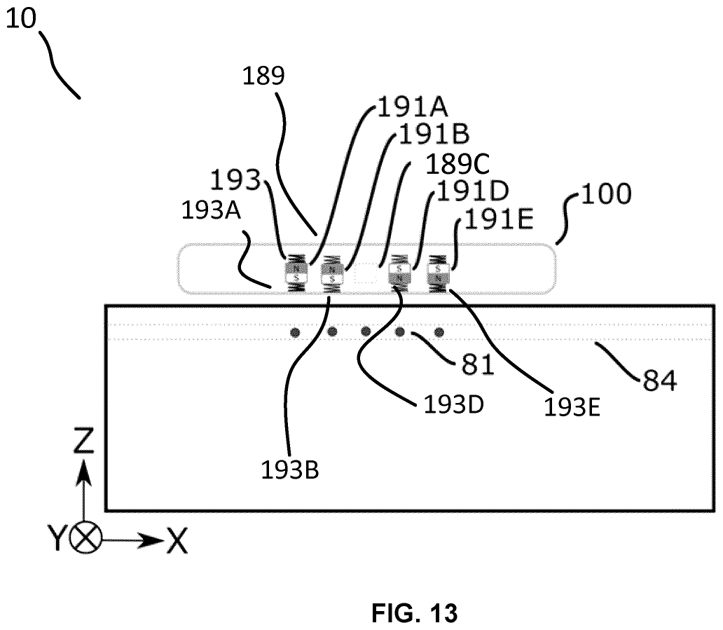

FIG. 13 depicts a further embodiment for storing additional information in magnetic identifying element 191. Magnetic identifying element 191 may include both magnets 191A, 191B, 191D, 191E and non-rigid connectors 193A, 193B, 193D, 193E (collectively non-rigid connectors 193), which may be disposed at reference locations 189. As will be discussed below, non-rigid connectors 193A, 193B, 193D, 193E may be used to store additional information in magnetic identifying element 191 beyond the data encoded within magnets 191A, 191B, 191D, 191E. At least one of non-rigid connectors 193 disposed within magnetic identifying element 191 may be configured to allow at least one of magnets 191A, 191B, 191D, 191E to move relative to mover 101. In other words, at least one non-rigid connector 193 may connect at least one of magnets 191A, 191B, 191D, 191E to mover device 100, and may permit movement of the at least one of magnets 191A, 191B, 191D, 191E relative to mover 101.

It will be appreciated that at least one reference location 189C may correspond to a neutral value, and thus may contain a non-magnetic element or no magnetic element at all. In such a situation, the corresponding non-rigid connector may also be absent at reference location 189C.

Sensors 81 may be arranged in stator module 200 below working surface 202 in a sensor plane 84.

Connecting magnets 191A, 191B, 191D, 191E to the mover device 100 with non-rigid connector 193 may allow magnets 191A, 191B, 191D, 191E to move relative to mover device 100, such as in the Z direction. Using sensors 81 to measure a position of at least one of magnets 191A, 191B, 191D, 191E relative to mover device 100 may allow the relative motion characteristics of the magnet to be calculated. For example, dynamic motion characteristics can be calculated (i.e. stiffness of the non-rigid connector). Using variable non-rigid connectors 193 or a mix of rigid and non-rigid connectors may create additional permutations that may be used to increase the overall number of permutations for an identification pattern with a fixed number of magnets.

In some embodiments, one or more non-rigid connectors 193 may be a spring.

In an example, controller 300 may be configured to determine at least one oscillation associated with non-rigid connectors 193 (e.g. springs) from variation in at least one magnetic field measured by sensors 81. Controller 300 may further determine at least one spring constant associated with non-rigid connectors 193 based on the at least one oscillation. Controller 300 may further identify mover device 100 based on the at least one spring constant. Controller 300 may identify mover device 100 based on both the at least one spring constant and the values of magnets 191A, 191B, 191D, 191E measured by sensors 81 at reference locations 189.

It will be understood that a user of mover device 100 may encode new or different identification information into mover device 100 by re-arranging, removing, replacing and/or adding non-rigid connectors 193 and magnets in magnetic identifying element 191.

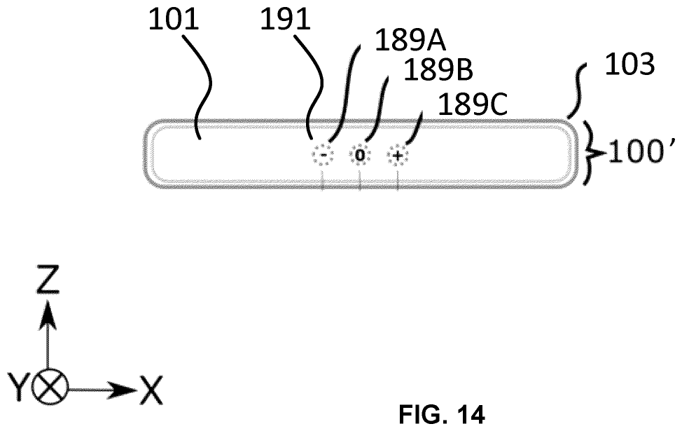

FIG. 14 depicts mover device 100′, which includes a wrapping layer 103. Wrapping layer 103 may be formed of a conductive material, or alternatively formed of some other material. Wrapping layer 103 may enclose at least one actuation magnet 110 and magnetic identifying element 191. Mover device 100′ may be otherwise identical to mover device 100.

For some applications, it may be desirable to enclose mover device 100′ with metallic material to separate the internal components of mover device 100′, such as actuation magnets 110 and magnetic identifying elements 191, from the external environment. Separation of the internal mover device 100′ environment from the external environment may prevent the impact of hostile environments (e.g. acidic, caustic, ultraviolet, humidity etc.) on mover device 100′, which may adversely affect internal parts of mover device 100′. The separation may also avoid contaminating sensitive environments (e.g. particles, bacteria, contaminants). Additionally, wrapping mover device 100′ in an impermeable and easy to clean material (e.g. stainless steel) may facilitate operating mover device 100′ in a hygienic environment.

The use of a conductive material to wrap the mover may create difficulties for existing identification solutions using electromagnetic communication since conductive layer 101 of mover device 100′ may shield stator module 200 from the desired communication signals originating from (or going to) mover device 100′. By using fixed value permanent magnets within magnetic identifying element 191, magnetic fields originating from reference locations 189A, 189B, 189C may still be measurable through conductive wrapping layer 103 if the magnetic field is strong enough. Additionally, the material from which conductive wrapping layer 103 is made of may be selected to minimize the reduction of the measurable strength of magnetic identifying element 191 by the sensors 81, such as by using low-magnetic or non-magnetic materials.

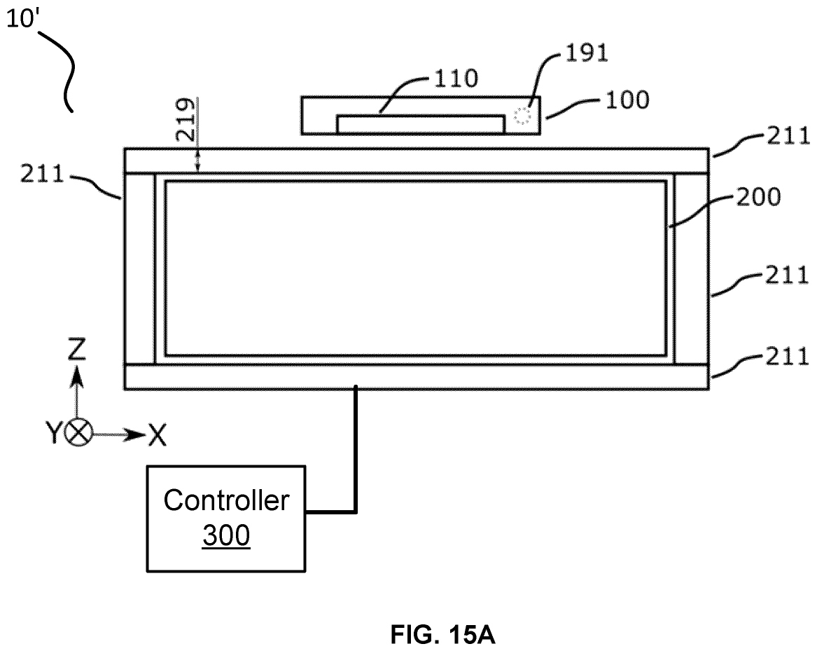

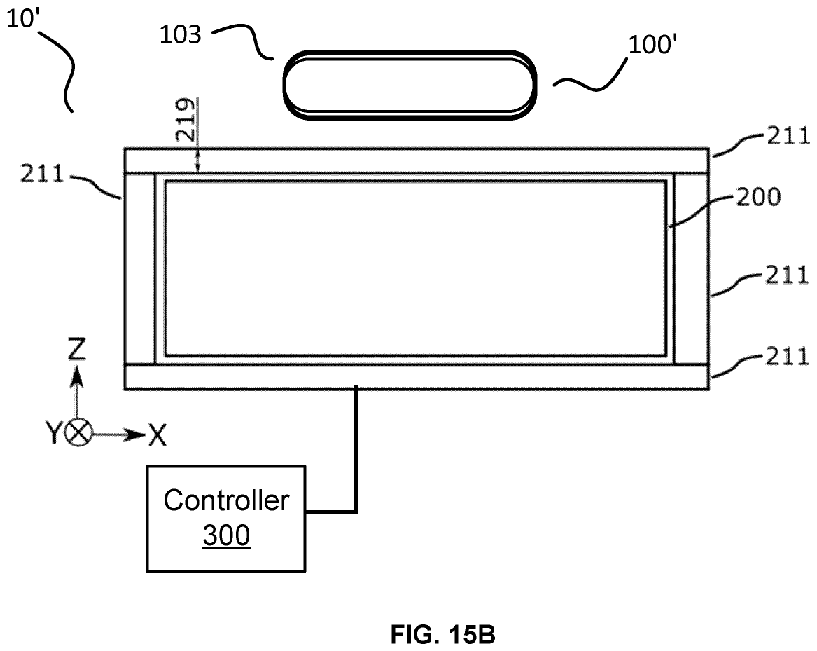

FIG. 15A depicts displacement system 10′, in which mover device 100 positioned above stator module 200 may be separated by a separating layer 211, which may be a conductive layer (e.g. stainless steel, or some other conductive material) or some other non-conductive material. As depicted, separating layer 211 may extend along working surface 202 of stator module 200 and may fully enclose all of stator module 200. Displacement system 10′ may be otherwise identical to displacement system 10.

Separating layer 211 may provide benefits including structural support, further isolation of particular environments, cleanability, wear-resistance, and electrical grounding, in addition to other benefits.

In some particular cases, separating layer 211 may only be separate mover device 100 and stator module 200 extending along working surface 202, such as to create a protective surface when landing or sliding along working surface 202 or allowing grounding of mover device 100.

In a typical displacement system, if a device requiring the use of electromagnetic communication is used to identify mover device 100, a separating layer may shield the stator module from the desired communication signals coming from the mover device. Shielding of communication between the mover device and stator module may reduce the effectiveness and, in some cases, could prevent communication that may be used to identify the mover device. However, in displacement system 10′, by using fixed value permanent magnets within magnetic identifying element 191, magnetic identifying element 191 may be easily measurable through separating layer 211 if the magnetic field is strong enough. Additionally, the material from which separating layer 211 is formed may be selected to minimize the reduction of the measurable magnetic filed strength of magnetic identifying element 191 by sensors 81, such as by using low or non-magnetic materials.

The thickness 219 of separating 211 may be between 0.3 mm and 0.5 mm. Alternatively, thickness 219 may be less than 0.3 mm or greater than 0.5 mm.

In some embodiments, as depicted in FIG. 15B, displacement system 10′ may include mover device 100′, such that mover device 100′ includes wrapping layer 103 and stator module 200 includes separating layer 211.

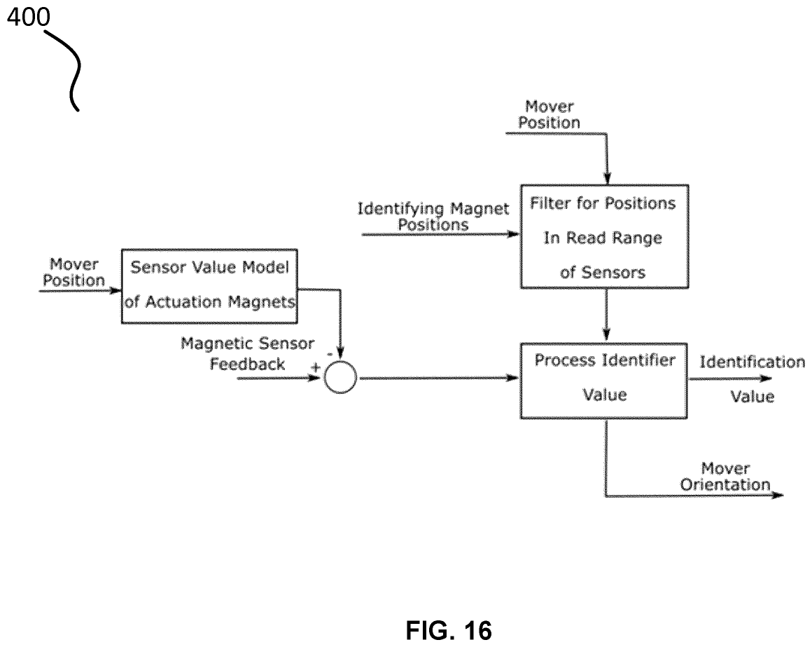

FIG. 16 depicts a method 400 for determining the orientation and identification information for mover device 100.

Method 400 may receive mover position as an input into the sensor value model of actuation magnets 110. The sensor value model of actuation magnets 110 may be subtracted from the magnetic sensor feedback (i.e. the measured values of sensors 81). This may result in a more accurate value for the magnets in magnetic identifying element 191 measured by sensors 81.

Mover position may also be input with identifying magnet positions (e.g. magnets 191A, 191B, 191C in magnetic identifying element 191 and/or reference locations 189) into a filter. The filter may filter for positions in the read range of sensors 81.

The filter output and the accurate value for the magnets in magnetic identifying element 191 measured by sensors 81 may then be used to process an identifier value, which may result in the determination of an identification value (i.e. identification information) for mover device 100. As well, the orientation of mover device 100 may also be determined.

It will be appreciated that other methods may be possible for determining the identification value and/or orientation of mover device 100. As well, fewer or additional steps may be performed in method 400.

The results of multiple measurement positions may be combined to identify the complete identification value of mover device 100. Although magnetic identifying element 191 may interact with the magnetic field generated by coils 210 in stator module 200 to generate a positive or negative effect, magnetic identifying element 191 may be configured such that the contributing forces relative to actuation magnets 110 may be small. For example, magnets 191A, 191B, 191C in magnetic identifying element 191 and/or actuation magnets 110 may be selected such that actuation magnets 110 are more than 50% larger than magnets 191A, 191B, 191C in magnetic identifying element 191. Alternatively, magnets 191A, 191B, 191C and/or actuation magnets 110 may be selected such that actuation magnets 110 are more than 100% larger than magnets 191A, 191B, 191C in magnetic identifying element 191.

Each actuation magnet 110 may have a length in a longest dimension of the actuation magnet 110. The length of each actuation magnet 110 may be larger than a longest dimension of each of magnets 191A, 191B, 191C in magnetic identifying element 191. In other embodiments, the length of each actuation magnet 110 may be more than 50% larger than the longest dimension of each of magnets 191A, 191B, 191C in magnetic identifying element 191. In further embodiments, the length of each actuation magnet 110 may be more than 100% larger than the longest dimension of each of magnets 191A, 191B, 191C in magnetic identifying element 191.

Each actuation magnet 110 may have a magnetic field strength, and the magnetic field strength of each actuation magnet 110 may be larger than a magnetic field strength of each of magnets 191A, 191B, 191C in magnetic identifying element 191. In other embodiments, the magnetic field strength of each actuation magnet 110 may be more than 10% larger than the magnetic field strength of each of magnets 191A, 191B, 191C in magnetic identifying element 191. In further embodiments, the magnetic field strength of each actuation magnet 110 may be more than 30% larger than the magnetic field strength of each of magnets 191A, 191B, 191C in magnetic identifying element 191.

Additionally, although reference locations 189 may be read by sensor 81 at a single location, the same reference locations 189 (e.g. reference location 189A) may be read at several identifying locations to increase reading certainty. In this way, the impact of actuation magnets 110 on the identification information stored within magnetic identifying element 191 and read by sensors 81 may be reduced.

In one particular example, sensor 81 may read magnetic identifying element 191 by identifying the position of mover device 100 and removing the impact of magnets 110 from measurements by sensors 81 to isolate the value of one or more magnets 191A, 191B, 191C in magnetic identifying element. Although the intensity/strength of the magnets 191A, 191B, 191C may be small enough to minimize the impact on mover device 100 position detection, the intensity/strength of the magnets 191A, 191B, 191C as measured by sensor 81 at locations 189 may be greater than the measurement noise from each of sensors 81. Similarly, the intensity of each magnet may be configured to be greater than any variability in strength of actuation magnets 110 measurable by sensors 81.

Identifying mover device 100 in this way through sensors 81 may be done during motion of mover device 100, or while mover device 100 is stationary (in levitated, landed, or deactivated operation). If controller 300 identifies mover device 100 during motion or levitation, the impact on the magnetic field generated by coils 210 may be removed by subtracting the calculated effect of coils 210. The calculated effect of coils 210 may be based on the current supplied to coils 210 at the time of measurement (or some similar compensation method) to further isolate the values of magnets in magnetic identifying element 191 measured with sensors 81.

In some embodiments, any position of mover device 100 on stator module 200 may be used as an identifying position.

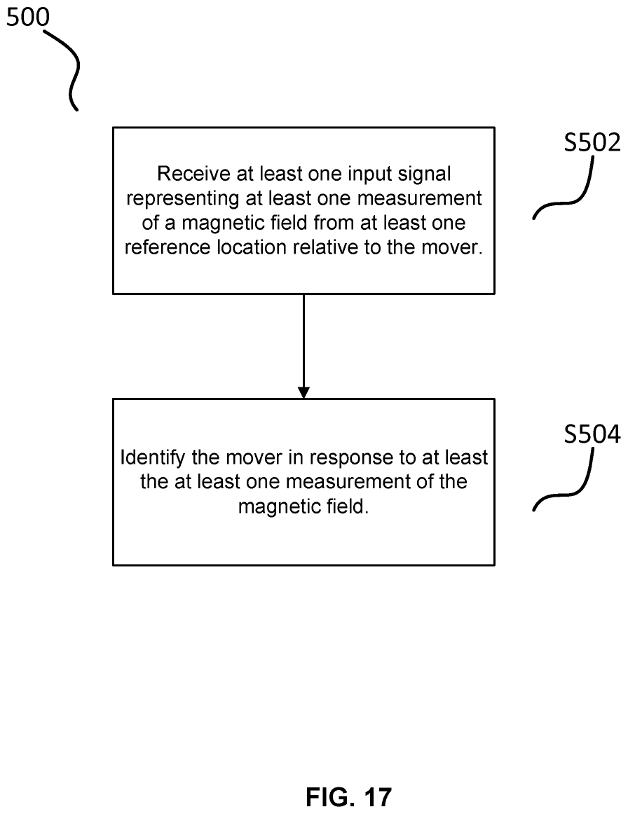

FIG. 17 depicts a method 500 for identifying mover device 100. Method 500 may be executed by controller 300. Therefore, method 500 is an example of a method for identifying a mover, the method including: receiving at least one input signal representing at least one measurement of a magnetic field from at least one reference location relative to the mover; and identifying the mover in response to at least the at least one measurement of the magnetic field.

Identifying mover 101 and thus mover device 100 may include distinguishing mover device 100 from other mover devices.

At step S502, controller 300 receives at least one input signal representing at least one measurement of a magnetic field from at least one reference location 189 relative to mover 101.

At least one magnetic field may be generated by at least one of magnets 191A, 191B, 191C in magnetic identifying element 191, located at at least one of reference locations 189. In other words, the at least one measurement of the magnetic field may represent at least magnetic influence from at least one identifying magnet, such as at least one of magnets 191A, 191B, 191C, on mover 101.

The input signal may further represent at least one measurement of a magnetic field associated with at least one identifying magnet, such as at least one of magnets 191A, 191B, 191C, on mover device 100.

In other embodiments, the at least one magnetic field may be generated by at least one of actuation magnets 110, which may be located at at least one of reference locations 189. In other words, the at least one measurement of the magnetic field may represent at least magnetic influence from at least one actuation magnet 110 on mover 101.

The input signal may further represent at least one measurement of a magnetic field associated with at least one actuation magnet 110 on mover device 100.

The at least one input signal may be generated by at least one of sensors 81, in response to at least one of sensors 81 measuring a portion of or all of magnetic identifying element 191 and/or actuation magnets 110.

Sensors 81 may measure the at least one magnetic field from the at least one reference location 189 while mover device 100 is moving, levitating or both. In other words, at least one sensor 81 may measure the at least one measurement of the magnetic field. For example, controller 300 may cause at least one sensor 81 may measure the at least one measurement of the magnetic field. The at least one sensor 81 may also measure the at least one measurement of the magnetic field while mover 101 is moving, levitating or both.

At step S504, controller 300 identifies mover 101 and thus mover device 100 in response to at least the at least one measurement of the magnetic field.

As noted above, the magnetic field may be associated with at least one identifying magnet on mover device 100, such as one of magnets 191A, 191B, 191C in magnetic identifying element 191. In other words, identifying mover 101 and thus mover device 100 may include identifying mover 101 according to at least the magnetic influence from the at least one identifying magnet, such as one of magnets 191A, 191B, 191C in magnetic identifying element 191.

Identifying mover 101 and thus mover device 100 in response to at least the at least one measurement of the magnetic field may further include identifying mover 101 in response to at least one measurement of the magnetic field associated with the at least one identifying magnet, such as at least one of magnets 191A, 191B, 191C, on mover 101.

It will be appreciated that in some embodiments, the at least one magnetic field may instead be generated by one or more of actuation magnets 110, which may also be located at at least one of reference locations 189. In other words, identifying mover 101 and thus mover device 100 may include identifying mover 101 according to at least the magnetic influence from at least one actuation magnet 110, such as one of magnets 191A, 191B, 191C in magnetic identifying element 191.

Identifying mover 101 and thus mover device 100 in response to at least the at least one measurement of the magnetic field may further include identifying mover 101 in response to at least one measurement of the magnetic field associated with the at least one actuation magnet 110 on mover 101.

Mover 101 may also be identified according to at least the magnetic influence from actuation magnets 110 and relative spatial characteristics of actuation magnets 110 with respect to each other. Identifying mover 101 may include identifying a relative pitch and/or orientation between two or more of the plurality of actuation magnets 110.

In further embodiments, mover device 100 and thus mover device 110 may be identified based solely on measurements of actuation magnets 110, without use of identifying magnets, such as magnets 191A, 191B, 191C in magnetic identifying element 191.

Controller 300 may determine, for each reference location 189 of one or more of the at least one reference location 189, a characterization of the magnetic field of the reference location 189.

The determination of the characterization of the magnetic field by controller 300 may also include identifying the magnetic field as having one of at least two different available characterizations for the magnetic field of the one or more of the at least one reference location 189. The at least two different available characterizations for the magnetic field from a reference location 189 may include a magnetic field resulting from a magnet at the reference location 189 and polarized in a first direction relative to the mover; and a magnetic field resulting from a magnet at the reference location 189 and polarized in a second direction relative to the mover and different from the first direction.

Alternatively, the at least two different available characterizations for the magnetic field from a reference location 189 may include a magnetic field resulting from a magnet at the reference location with a first magnetic blemish; and a magnetic field resulting from a magnet at reference location 189 with a second magnetic blemish, wherein the second magnetic blemish is different from the first magnetic blemish. The first magnetic blemish may be intentionally created.

In other embodiments, the determination of the characterization of the magnetic field by controller 300 may also include identifying the magnetic field as having one of at least three different available characterizations for the magnetic field of the one or more of the at least one reference location 189. The at least three different available characterizations for the magnetic field from a reference location 189 may include: a magnetic field resulting from a magnet at the reference location 189 and polarized in a first direction relative to the mover; a magnetic field resulting from a magnet at the reference location 189 and polarized in a second direction relative to the mover and different from the first direction; and an absence of a magnet at the reference location 189.

The different available characterizations for each magnetic field of the one or more of the at least one reference location 189 may include different magnetic field strengths of magnets at the one or more of the at least one reference location 189. For example, magnets 191A, 191C disposed at reference locations 189A, 189C may be configured with different magnetic field strengths.

Controller 300 may compare the characterization for the magnetic field to identifying information stored in database 340 to identify mover 101 and thus mover device 100.

In some embodiments, method 500 may further include the step of pre-processing the at least one input signal to create at least one pre-processed signal. Identifying the mover may include identifying the mover in response to at least the at least one pre-processed signal. Pre-processing the at least one input signal may include at least one of high-pass filtering, band-pass filtering and compensating the at least one input signal.

Compensating the at least one input signal may include removing the impact of at least one of actuation magnets 110 on mover device 100 from the input signal.

Method 500 may also include the step of identifying at least a position of mover 101 in response to at least the at least one measurement of the magnetic field.

Method 500 may further include the step of identifying at least an orientation of mover 101 and thus mover device 100 in response to at least the at least one measurement of the magnetic field.

Method 500 may also include the step identifying mover 101 and thus mover device 100 in response to at least movement of one or more of at least one identifying magnet relative to the mover. At least one identifying magnets may include at least one of magnets 191A, 191B, 191C in magnetic identifying element 191.

In other embodiments, method 500 may also include the step of determining at least one magnetic field of at least one of actuation magnets 110 on mover device 100. In such embodiments, controller 300 may identify mover device 100 based on at least on magnetic field associated with at least one of actuation magnets 110. Identification information association the magnetic field of the at least one actuation magnets 110 with mover device 100 may be stored in database 340.

It will be appreciated that controller 300 may also identify mover device 100 based on magnetic fields associated with magnetic identifying element 191 and at least one of actuation magnets 110.

Identifying mover 101 and thus mover device 100 may include identifying mover 101 in response to at least an identification of mover 101 associated in at least one database 340 with the magnetic field from the at least one reference location 189.

Method 500 may further include causing mover 101 to move, wherein causing mover 101 to move includes causing one or more external magnetic fields to interact with at least one actuation magnet 110.

It will be appreciated that method 500 may include actuating one or more of at least one actuation magnet 110 independently of the at least one identifying magnet, such as at least one of magnets 191A, 191B, 191C in magnetic identifying element 191. In other words, method 500 may also include causing mover 101 to move, wherein causing mover 101 to move includes one or more external magnetic fields to interact with at least one actuation magnet 110 independently of the at least one identifying magnet.

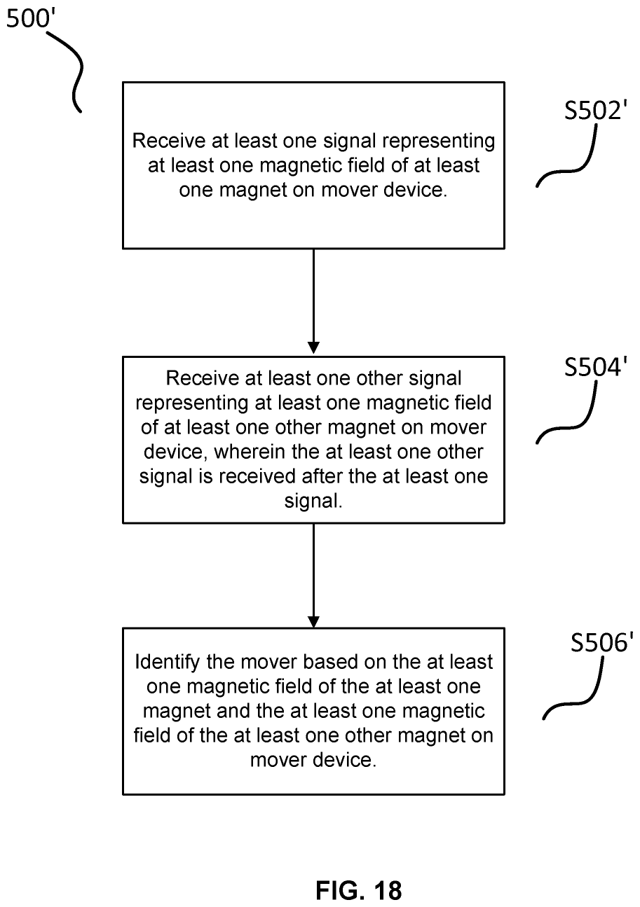

FIG. 18 depicts another method 500′ for identifying mover device 100, according to another embodiment. Method 500′ may also be executed by controller 300.

At step S502′, controller 300 receives at least one signal representing at least one magnetic field of at least one magnet on mover device 100.

At least one magnet may be at least one of magnets 191A, 191B, 191C in magnetic identifying element 191. In an example, the at least one magnet may be magnet 191A.

At step S504′, controller 300 receives at least one other signal representing at least one magnetic field of at least one other magnet on mover device 100. The at least one other signal is received after the at least one signal received at step S502′.

The at least one other magnet may be at least one of magnets 191A, 191B, 191C in magnetic identifying element 191. In the example, the at least one other magnet may be magnets 191B, 191C.

At step S506′, controller 300 identifies mover device 100 based on the at least one magnetic field of the at least one magnet and the at least one magnetic field of the at least one other magnet on mover device 100. Identifying mover device 100 may include distinguishing mover device 100 from other mover devices.

In the example, controller 300 may be configured to identify mover based on magnetic fields identifying magnets 191A, 191B, 191C on mover device 100, such that controller 300 may have received signals representing all of magnets 191A, 191B, 191C in magnetic identifying element 191.

It will be appreciated that magnetic identifying element 191 may include fewer or more magnets than magnets 191A, 191B, 191C.

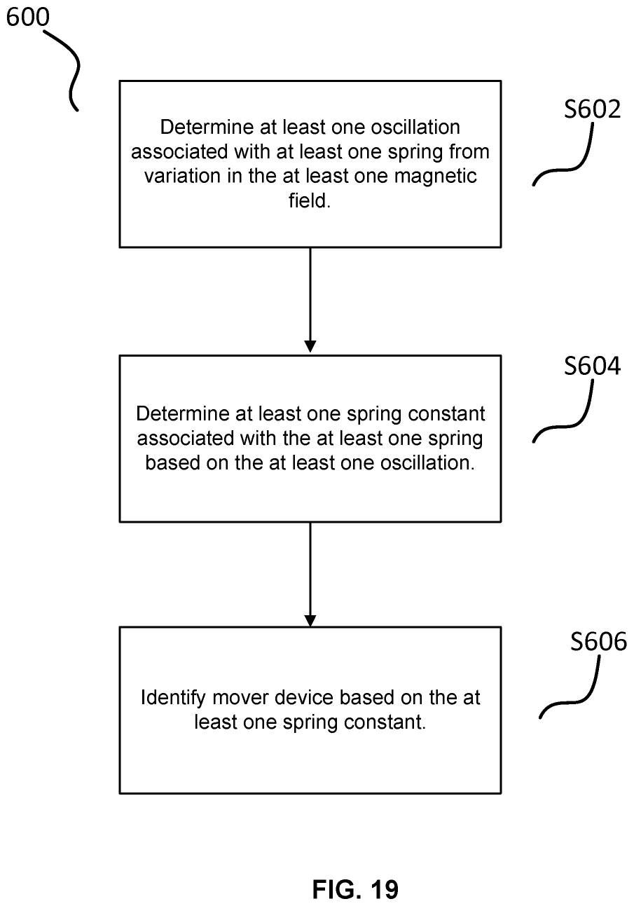

FIG. 19 depicts a method 600 for identifying mover device 100, according to another embodiment. Method 600 may be executed concurrently with step S504 in method 500. Method 600 may also be executed by controller 300. Therefore, method 600 is an example of identifying mover 101 and thus mover device 100 in response to at least the movement of the one or more of the at least one identifying magnet relative to move 101r, including identifying mover 101 in response to at least oscillation of the one or more of the at least one identifying magnet relative to mover 101. Identifying magnet may be any one of magnets 191A, 191B, 191C in magnetic identifying element 191.

At step S602, controller 300 determines at least one oscillation associated with at least one spring from variation in the at least one magnetic field. The at least one magnetic field may be associated with the signal received at step S502 in method 500.

The at least one spring may be at least one of non-rigid connectors 193.

At step S604, controller 300 determines at least one spring constant associated with the at least one spring based on the at least one oscillation.

At step S606, controller 300 identifiers mover device 100 based on the at least one spring constant. Controller 300 may also identify mover device based on other information associated with the at least one magnetic field, such as at least one value associated with the at least one magnetic field.

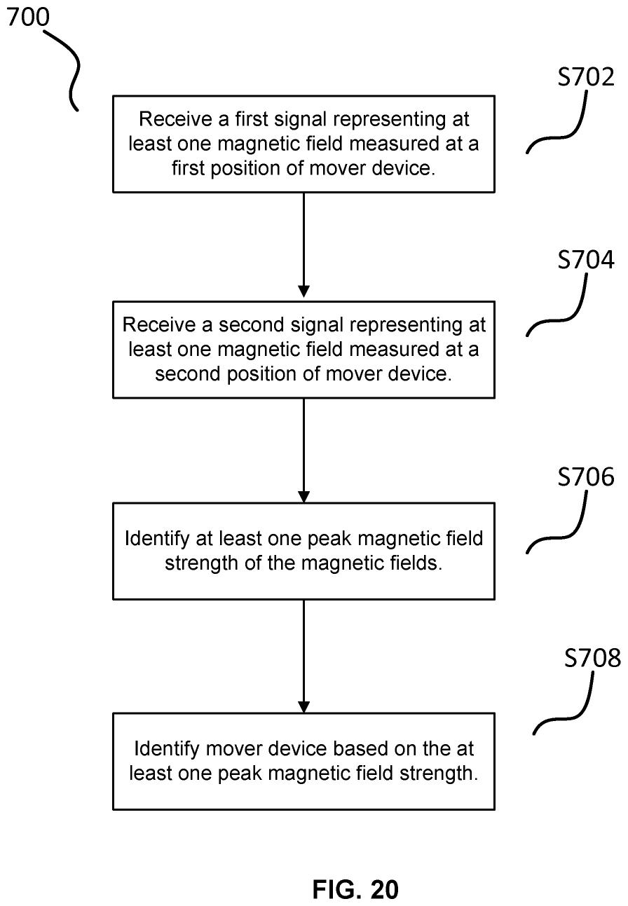

FIG. 20 depicts a method 700 for identifying mover device 100, according to another embodiment. Method 700 may also be executed by controller 300.

At step S702, controller 300 receives a first signal representing at least one magnetic field measured at a first position of mover device 100. First position of mover device 100 may be a first position on working surface 202, and may be associated with at least one sensor 81 with at least one measurement range 83 overlapping with first position.

At step S704, controller 300 receives a second signal representing at least one magnetic field measured at a second position of mover device 100. Second position of mover device 100 may be a second position on working surface 202, and may be associated with at least one sensor 81 with at least one measurement range 83 overlapping with second position.

At step S706, controller 300 identifies at least one peak magnetic field strength of the magnetic fields. The magnetic fields correspond to the at least one magnetic field associated with the first signal and the at least one magnetic field of the second signal.

For example, controller 300 may first generate magnetic field strength curve 196 based on first signal measured at first position and second signal measured at second position. Controller 300 may identify at least one of peak magnetic field strengths 196A, 196B, 196C.

It will be appreciated that at least one peak magnetic field strength may be determined using magnetic fields associated with signals from more than two positions, such as many different positions. This may allow controller 300 to generate magnetic field strength curve 196 with a dense collection of points.

At step S708, controller 300 identifiers mover device 100 based on the at least one peak magnetic field strength. For example, database 340 may contain information associating the at least one peak magnetic field strength with mover device 100.

It will be appreciated that mover device 100 may also be identified based on other information associated with the at least one peak magnetic field strength, such as the spacing between multiple peak magnetic field strengths.

Of course, the above-described embodiments are intended to be illustrative only and in no way limiting. The described embodiments are susceptible to many modifications of form, arrangement of parts, details and order of operation. The invention is intended to encompass all such modification within its scope, as defined by the claims.

1. A method of identifying a mover, the method comprising:
receiving at least one input signal representing at least one measurement of a magnetic field from at least one reference location relative to the mover; and
identifying the mover in response to at least the at least one measurement of the magnetic field.

2. The method of claim 1, wherein identifying the mover in response to at least the at least one measurement of the magnetic field comprises determining, for each reference location of one or more of the at least one reference location, a characterization of the magnetic field of the reference location.

3. (canceled)

4. The method of claim 2, wherein determining the characterization of the magnetic field comprises identifying the magnetic field as having one of at least two different available characterizations for the magnetic field of the one or more of the at least one reference location, the at least two different available characterizations for the magnetic field from a reference location comprising:
a magnetic field resulting from a magnet at the reference location and polarized in a first direction relative to the mover; and
a magnetic field resulting from a magnet at the reference location and polarized in a second direction relative to the mover and different from the first direction.

5. (canceled)

6. The method of claim 2, wherein determining the characterization of the magnetic field comprises identifying the magnetic field as having one of at least three different available characterizations for the magnetic field of the one or more of the at least one reference location, the at least three different available characterizations for the magnetic field from a reference location comprising:
a magnetic field resulting from a magnet at the reference location and polarized in a first direction relative to the mover;
a magnetic field resulting from a magnet at the reference location and polarized in a second direction relative to the mover and different from the first direction; and
an absence of a magnet at the reference location.

7. The method of claim 2, wherein determining the characterization of the magnetic field comprises identifying the magnetic field as having one of at least two different available characterizations for the magnetic field of the one or more of the at least one reference location, the at least two different available characterizations for the magnetic field from a reference location comprising:
a magnetic field resulting from a magnet at the reference location with a first magnetic blemish; and
a magnetic field resulting from a magnet at the reference location with a second magnetic blemish, wherein the second magnetic blemish is different from the first magnetic blemish.

8. (canceled)

9. The method of claim 2 wherein determining the characterization of the magnetic field comprises identifying the magnetic field as having one of at least two different available characterizations for the magnetic field of the one or more of the at least one reference location, the different available characterizations for the magnetic field of the one or more of the at least one reference location comprising different magnetic field strengths of magnets at the one or more of the at least one reference location.

10-14. (canceled)

15. The method of claim 1, further comprising identifying at least an orientation of the mover in response to at least the at least one measurement of the magnetic field.

16. (canceled)

17. (canceled)

18. The method of claim 1, further comprising causing at least one sensor to measure the at least one measurement of the magnetic field while the mover is levitating.

19. (canceled)

20. The method of claim 1, wherein identifying the mover comprises identifying the mover in response to at least an identification of the mover associated in at least one database with the magnetic field from the at least one reference location.

21-26. (canceled)

27. The method of claim 1, wherein:
the at least one measurement of the magnetic field represents at least magnetic influence from at least one of a plurality of identifying magnets of the mover;
the plurality of identifying magnets is positioned on the mover such that a first identifying magnet of the plurality of identifying magnets is spaced apart from a second identifying magnet of the plurality of identifying magnets in a first direction and is spaced apart from a third identifying magnet of the plurality of identifying magnets in a second direction non-parallel to the first direction; and
identifying the mover comprises identifying the mover according to at least the magnetic influence from the at least one of the plurality of identifying magnets.

28. The method of claim 1, wherein:
the at least one measurement of the magnetic field represents at least magnetic influence from at least one identifying magnet of the mover; and
identifying the mover comprises identifying the mover according to at least the magnetic influence from the at least one identifying magnet and in response to at least movement of one or more of the at least one identifying magnet relative to the mover.

29. (canceled)

30. The method of claim 1, further comprising causing the mover to move in at least two degrees of freedom, wherein causing the mover to move in at least two degrees of freedom comprises causing one or more external magnetic fields to interact with at least one actuation magnet of the mover.

31-33. (canceled)

34. A mover device comprising:
a mover comprising at least one actuation magnet configured to generate forces for moving the mover device in response to at least one external magnetic field; and
at least one identifying magnet, wherein the at least one identifying magnet is encoded with identification information distinguishing the mover from other movers.

35. (canceled)

36. The mover device of claim 34, wherein:
the at least one identifying magnet comprises a plurality of identifying magnets:
the mover defines a plurality of reference locations, and
each identifying magnet of the plurality of identifying magnets is at a respective different one of the plurality of reference locations.

37. The mover device of claim 36, wherein the plurality of reference locations are in at least one column and at least one row on the mover, wherein magnetic fields of any magnets in each of the at least one column and each of the at least one row counteract each other when combined together.

38. The mover device of claim 36, wherein at least some of the plurality of reference locations are in a periphery of the mover surrounding the at least one actuation magnet.

39. The mover device of claim 36, wherein at least some of the plurality of reference locations are surrounded by the at least one actuation magnet.

40-42. (canceled)

43. The mover device of claim 34, wherein:
the at least one identifying magnet comprises a plurality of identifying magnets;
each actuation magnet of the at least one actuation magnet has a length in a longest dimension of the actuation magnet; and
the length of each actuation magnet of the at least one actuation magnet is larger than a length in a longest dimension of each identifying magnet of the plurality of identifying magnets.

44. (canceled)

45. (canceled)

46. The mover device of claim 34, wherein:
the at least one identifying magnet comprises a plurality of identifying magnets;
each actuation magnet of the at least one actuation magnet has a magnetic field strength; and
the magnetic field strength of each actuation magnet of the at least one actuation magnet is larger than a magnetic field strength of each identifying magnet of the plurality of identifying magnets.

47. (canceled)

48. (canceled)

49. The mover device of claim 34, wherein:
the at least one actuation magnet comprises a plurality of actuation magnets having a magnetic pitch; and
the at least one identifying magnet comprises a plurality of identifying magnets having a magnetic pitch different from the magnetic pitch of the plurality of actuation magnets.

50. The mover device of claim 34, wherein:
the at least one identifying magnet comprises a plurality of identifying magnets;
at least three of the plurality of identifying magnets are arranged generally in a line with a non-uniform magnetic oscillation; and
a first magnetic pitch between first and second identifying magnets of the plurality of identifying magnets is different from a second magnetic pitch between second and third identifying magnets of the plurality of identifying magnets.

51. The mover device of claim 34, wherein:
the at least one identifying magnet comprises a plurality of identifying magnets; and
at least three of the plurality of identifying magnets are arranged generally in a line with a non-uniform magnetic oscillation comprising two sequential magnets with similar magnetic orientation.

52. The mover device of claim 34, wherein:
the at least one actuation magnet is rotationally symmetric about an axis; and
one or more magnetic fields from the at least one identifying magnet are rotationally asymmetric about the axis.

53. The mover device of claim 34, wherein the mover device is wrapped in conductive material.

54-60. (canceled)

61. The mover device of claim 34, wherein the at least one actuation magnet is configured to generate forces for moving the mover device in at least two degrees of freedom.

62-65. (canceled)

66. The mover device of claim 36, wherein a first reference location of the plurality of reference locations is spaced apart from a second reference location of the plurality of reference locations in a first direction and is spaced apart from a third reference location of the plurality of reference locations in a second direction non-parallel to the first direction.
